(19) United States
(12) Patent Application Publication
(10) Pub. No.: US 2025/0367646 A1
(43) Pub. Date: Dec. 4, 2025

(54) CONTROLLED ALKALINE TREATMENTS ON MOLECULAR SIEVES

(71) Applicant: KATHOLIEKE UNIVERSITEIT LEUVEN, Leuven (BE)

(72) Inventors: Bert SELS, Westerlo (BE); Nicolas NUTTENS, Heverlee (BE); Danny VERBOEKEND, Tienen (BE)

(21) Appl. No.: 19/003,417

(22) Filed: Dec. 27, 2024

Related U.S. Application Data
(63) Continuation of application No. 16/071,391, filed on Jul. 19, 2018, now abandoned.
(60) Provisional application No. 62/438,693, filed on Dec. 23, 2016.

(30) Foreign Application Priority Data
Feb. 29, 2016 (GB) 1603487.8

(51) Int. Cl. B01J 29/08; B01J 29/40; B01J 29/70; B01J 29/85; B01J 35/59; C01B 39/02; C01B 39/54

(52) U.S. Cl. CPC B01J 29/084; B01J 29/40; B01J 29/7007; B01J 29/85; B01J 35/59; C01B 39/026; C01B 39/54; B01J 2229/38

(57) ABSTRACT

This invention relates generally to a process to perform controlled alkaline treatments on inorganic porous solids, yielding superior physico-chemical and catalytic properties, whereas the particle and crystal size is not negatively influenced. Accordingly, the solids obtained in this fashion can be easily recovered from the alkaline solution. The latter being problematic in the state of the art.

### INCORPORATION BY REFERENCE TO ANY PRIORITY APPLICATIONS

This application is a continuation of U.S. patent application Ser. No. 16/071,391, which was filed Jul. 19, 2018, and which claims priority to PCT patent application number PCT/EP2017/054482, which was filed Feb. 2, 2017, and which claims priority to European patent application number 1603487.8, which was filed Feb. 29, 2016, and U.S. provisional patent application No. 62/438,693, which was filed Dec. 23, 2016; each of which are hereby expressly incorporated by reference in their entirety.

### FIELD

This invention generally relates to a process to perform controlled alkaline treatments on inorganic porous solids, yielding superior physico-chemical and catalytic properties, while the particle and crystal size is not negatively influenced. Accordingly, the solids obtained in this fashion can be easily recovered from the alkaline solution.

### BACKGROUND

Zeolites are microporous aluminosilicate oxide structures that have well-defined pore structures due to a high degree of crystallinity. Crystalline aluminosilicate zeolites can have a natural and a synthetic origin. In the protonic form, the crystalline aluminosilicate zeolites are generally represented by the formula, HₓAlₓSi₁₋ₓO₂, where “H” is a (exchangeable) proton that balances the electrovalence of the tetrahedra. The amount of exchangeable protons is referred to as the cation exchange capacity (CEC). The exact structure type of an aluminosilicate zeolite is generally identified by the particular silicon to aluminium molar ratio (Si/Al) and the pore dimensions of the cage structures. The size of the micropores (typically in the range of 0.4-1 nm) can be indicated with the number of T-atoms on the smallest diameter, the so called ‘membered rings’ (MRs). Using this definition, most common industrial zeolites feature micropores of 8 MRs, 10 MRs, or 12 MRs. The zeolite structure can also be made using, in addition to silica and alumina, phosphates, giving rise to the class of crystalline microporous silicoaluminophosphates (SAPOs). In addition, when silica is no longer present, crystalline microporous aluminophosphates (AIPOs) are formed. SAPOs and AlPOs possess, like zeolites, unique porous and acidic properties enabling them wide scale industrial application in catalysis, adsorption, and ion exchange.

Recently, hierarchical (mesoporous) zeolites, SAPOs, and AlPOs have attracted substantial attention because of their potential advantages in catalysis due to their high external surface area, reduced diffusion path lengths, and exposed active sites. The introduction of a secondary network of mesopores (typically in the range of 2-50 nm) leads to substantial changes in the properties of materials, which have an impact on the performance of zeolites in traditional application areas such as catalysis and separation. The number of accessible active sites increases rapidly with the enhanced porosity of the material. Additionally, the hierarchical zeolite crystals display reduced diffusion path lengths relative to conventional microporous zeolites, AlPOs, or SAPOs. Accordingly, these materials have attained superior performance in many catalytic reactions, such as cracking, alkylations, and isomerisations.

Hierarchical zeolites can be made using a wide variety of bottom-up and top-down procedures. Bottom-up procedures imply a change in the hydrothermal synthesis of the zeolites, for example by using organic templates or by lengthening the crystallization time. However, the most industrially attractive variant is the (top-down) post-synthetic modification of conventional commercially-available microporous zeolites. A key treatment in the latter category is the application of a base treatment, so called ‘desilication’. This approach entails contacting zeolites in alkaline aqueous solutions, yielding hierarchical zeolites by removing part of the solid to give way to intra-crystalline or inter-crystalline mesopores. Base treatments enable to convert nearly any conventional zeolite into its superior hierarchical analogue. Also, for SAPOs and AlPOs, base treatments enable to yield a superior catalytic counterpart.

Besides the aim of mesopore formation, thereby producing hierarchical crystalline materials, alkaline treatments can also be performed to wash unwanted phases from bi-phasic materials. For example, NaOH leaching can be used to remove undesirable ZSM-5 impurities from ZSM-22 zeolites. In addition, base leaching can be used to selectively leach elements from materials comprising a wide variety of elements. For example, when applied on zeolites, base leaching is selective to silicon. Conversely, when applied to SAPOs, base leaching is mostly selective to phosphorus. Hereby, base treatments enable to tune, besides the (meso) porosity, other physico-chemical properties of the resulting material, such as the bulk composition, distribution of elements in the crystals, and acidity.

Base treatments are performed by directly adding the zeolite to an aqueous solution of base, typically at high pH (>12), hence high base concentration (for example >0.1 M NaOH). This procedure is followed by filtration, typically executed by Buchner filtration. For 10 MR zeolites, for example framework topologies such as MFI, FER, TON, the use of only an inorganic base (typically NaOH) in the alkaline treatment typically suffices. However, for 12 MR zeolites, such as zeolites with the FAU or BEA topology, the addition of organics, such as tetrapropylammonium bromide (TPABr) or diethylamine, to the alkaline solution may be required to maintain the intrinsic zeolite properties, such as crystallinity, acidity, and microporosity. SAPOs and AlPOs are in general more sensitive than zeolites, requiring the use of (inorganic) salt-free alkaline solutions prepared by amines or TPAOH to yield superior solids.

Alkaline (base) treatments are often performed as a single treatment within a sequence of post-synthetic modifications. For example, to prepare a catalytically-superior hierarchical Y zeolite, a sequence of 3 consequent acid-base-acid treatments can be performed. Alternatively, for clinoptilolite (natural zeolite), a sequence of 6 consecutive treatments (acid 4 times, base, acid) was reported. Additionally, for ZSM-5 and ZSM-22 two treatments (base-acid) were reported. Following each individual treatment a filtration and drying step are required. In general, the acid treatment prior to the base treatment effectively removes aluminium from the zeolite framework, hereby enhancing the efficiency of the subsequent base treatment. Conversely, the acid treatment performed after the base treatment has been described as a mild acid wash, and is aimed predominantly at removing ‘Al-debris’ from the external surface. This Al debris has formed during the prior alkaline treatment. The efficiency of the acid wash is therefore closely tied to the efficiency of the prior alkaline treatment.

Besides the aforementioned advantages of the base leaching, it is imperative to highlight several severe disadvantages of base leaching. Firstly, the use of organics should be largely avoided, as they need to be removed by combustion. Not only does this process destruct the costly organics, the formed combustion products need to be carefully taken care of, which is a costly procedure in itself. Simple amines, such as diethylamine, used as base to leach 12 MR zeolites (beta and USY), AlPOs, and SAPOs, may be easily recovered due to their high volatility, enhancing its industrial appeal. However, the use of tetraalkylammonium cations (TAAs), such as TPABr and cetyltrimethylammonium bromide (CTABr), is preferably avoided as these are more costly, and they need to be removed by heat treatment giving rise to undesired streams such as CO₂, NOₓ, H₂O, and/or explosive organics. It is therefore of eminent importance to reduce the use of organics, especially TAAs.

Secondly, base leached zeolites, even under reportedly optimal conditions with organic molecules, typically display strongly enhanced mesoporosities. However, more often than not, they also can display undesired reductions of zeolitic properties. Representative examples hereof are the crystallinity, Brønsted acidity, and microporosity. These reductions have been reported for most hierarchical or mesoporous zeolites, as demonstrated in Table A of the example section.

An important recent development has been the realization that besides the amount of secondary porosity, the quality of the pore is of crucial importance too. It has been observed that, especially in high silica zeolites (Si/Al>ca. 10), base leaching may give rise to mesopores that are (partially) cavitated. In this case, the larger the cavitation, the smaller the catalytic benefits. Hence, at a constant mesopore surface or volume, the smallest possible degree of mesopore cavitation is desired.

Finally, base treatment can give rise to a pronounced reduction of the zeolite crystal size. This reduction is related to a fragmentation which may give rise to fragments in the size range of 5-100 nm. These represent colloidally-stable particles that are very hard to separate using conventional filtration techniques over porous filter membranes, and require the use of costly industrial separation techniques, such as high-speed commercial centrifuges. Accordingly, the zeolite suspensions after base leaching are often extremely hard to filter, as demonstrated in Table A of the example sample.

Hence, it is desirable to provide a more efficient process that yields the same base leaching effect (enhanced mesoporosity), but yields solids comprising higher intrinsic zeolitic properties, a reduced degree of cavitation, a reduced amount of organic supplements, and/or preserved crystal size. In addition, such superior process preferably features a similar or reduction of the number of steps involved, the overall process time, and the amount of formed waste water. The obtained materials may have improved properties for the preparation of technical catalysts, or for use in catalysis, adsorptive or ion exchange processes.

### SUMMARY

In accordance with the purpose of the invention, as embodied and broadly described herein, the invention is broadly drawn to a process to perform alkaline treatment on inorganic porous solids yielding superior physico-chemical (zeolitic) and catalytic properties. These superior properties may the combination of an enhanced mesoporosity with a higher Brønsted acidity, a higher microporosity, a higher mesoporosity, a higher crystallinity, a larger fraction of framework aluminium, a reduced degree of cavitation of the mesopores, a larger crystal size, and/or combinations hereof.

In an aspect, the invention relates to a method for preparing a treated inorganic porous solid, wherein the method comprises a number of separate treatments (z) which are separated by a solid separation step, such as a filtration step, each of the z treatments comprising the steps of:
a) providing an inorganic porous solid, at an amount of mₛ;
b) providing a total amount of base m_{b,total}; and,
c) contacting and reacting the inorganic porous solid with an amount of base m_{b}(t) in a solution over a time frame Δt for the total amount of base m_{b,total};

thereby obtaining a treated inorganic porous solid;

wherein the maximum amount of base m_{b,max} of m_{b}(t) brought into contact with inorganic porous solid mₛ at any given time t in step c) is smaller than m_{b,total}/mₛ. The total amount of base can be provided in the form of a solid alkali or an alkaline solution, preferably an alkaline solution.

In some preferred embodiments, the maximum amount of base m_{b,max} of m_{b}(t) at any given time t in step c) is at most than 0.75*m_{b,total}, preferably at most than 0.50*m_{b,total}, preferably at most than 0.25*m_{b,total}.

In some preferred embodiments, the inorganic porous solid comprises a molecular sieve, such as a zeolite or SAPO.

In some preferred embodiments, step a) comprises:
a′) providing the inorganic porous solid at an amount of mₛ suspended in a solution, preferably in water.

In some preferred embodiments, the method comprises a number of base additions per treatment (x) which are not separated by a solid separation step, such as a filtration step, and an amount of base added per addition (m_{b,i} with i=1 . . . x), characterised in that x is not equal to 1, preferably wherein x is at least 2, preferably at least 3, preferably at least 4. In some preferred embodiments, z is 1.

In some preferred embodiments, the rate of adding the amount of base over time is at most 3.0 mmol g⁻¹ min⁻¹, preferably at most 1.0 mmol g⁻¹ min⁻¹, preferably at most 0.5 mmol g⁻¹ min⁻¹.

In some preferred embodiments, the base is continuously added to the inorganic porous solid during a time frame Δt, wherein the time frame Δt for adding the total amount of base m_{b,total} is at least 15 s.

In some preferred embodiments, the method is followed by a sequential acid treatment.

In an aspect, the invention relates to a treated inorganic porous solid obtainable by the method according to any one of the aspects and embodiments described herein.

In an aspect, the invention relates to a zeolite with the faujasite topology, preferably prepared according to the method according to any one of the aspects and embodiments described herein, with a unit cell size ranging from 24.375 Å to 24.300 Å with a mesopore volume of at least 0.35 ml/g and one or more of the following features:
a Brønsted acidity of at least 400 μmol g⁻¹, as measured with pyridine;
a fraction of Al in the framework of at least 0.5; and/or,
a crystallinity of at least 75% relative to a standard NaY zeolite, and at least 90% compared to NIST standard alumina (SRM 676).

In an aspect, the invention relates to a zeolite with the faujasite topology, preferably prepared according to the method according to any one of the aspects and embodiments described herein, with a unit cell size of at most 24.300 Å, with a mesopore volume of at least 0.35 ml g⁻¹, and one or more of the following features:
a micropore volume of at least 0.22 ml g⁻¹;
a crystallinity of at least 95% compared to a commercial NaY zeolite, and at least 130% compared to NIST standard alumina (SRM 676);
a mesopore cavitation ratio of at most 1.6, as measured with nitrogen adsorption; and/or,
with a particle size D_{eff} of at least 350 nm.

In an aspect, the invention relates to a zeolite with the MFI topology, preferably prepared according to the method according to any one of the aspects and embodiments described herein, with a molar Si/Al ratio of at most 400, with a mesopore volume of at least 0.30 ml g⁻¹ and a crystallinity of at least 330% compared to NIST standard alumina (SRM 676).

In an aspect, the invention relates to a method for preparing a technical catalyst, the method comprising the steps of:
preparing a treated inorganic porous solid according to any one of the aspects and embodiments described herein, or providing a porous solid according to any one of the aspects and embodiments described herein;
adding one or more additional ingredients to form a mixture, preferably wherein the one or more additional ingredients are selected from the group comprising: fillers, pyrogens, binders, lubricants, and combinations thereof; and
shaping the mixture into a macroscopic form to obtain a technical catalyst, preferably wherein the macroscopic form has a minimal dimension from at least 1 μm to at most 10 cm.

In an aspect, the invention relates to the use of a treated inorganic porous solid according to any one of the aspects and embodiments described herein, in catalysis, adsorptive or ion exchange processes.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 depicts a general process overview. Conventionally, in a fixed volume of water, first a base is added, after which the porous solid is added and left to react under vigorous mechanical stirring. In FIG. 1, however, there are multiple additions and/or multiple treatments. In FIG. 1, x represents the number of base additions per reaction, m₁(m_{b}) the amount of base added per addition, y the number of solid additions per reaction, m₂(mₛ) the amount of solid added per addition, and z represents the number of treatments. In the state of the art, x, y, and z are equal to 1. In the further embodiments in this detailed description, y and m₂(mₛ) are not modified.

FIG. 2 demonstrates a contacting of a porous solid to a base using in line configuration. In this configuration, the porous solid is located on a membrane and the (dilute) basic solution is contacted to it by flowing (f) it through the solid-covered membrane

FIG. 3 depicts a plug flow reactor where a suspension of solid in water (f₁) is co-fed with a base (f₂) into a tubular reactor. This configuration yields a contacting of the base as in a batch reactor, hence according the state of the art.

FIG. 4 depicts a plug flow reactor in which a suspension of solid (f₁) is fed through a tube. However, unlike the state of the art (described in FIG. 3), the base (f₂) is added in a number of steps (x) as a function of the position (and thus time) enabling the solid to react gradually or stepwise with the base.

FIG. 5 displays a continuous stirred tank reactor in which the solid remains in the reactor where it reacts with a steady flow of base (f) entering and leaving.

FIG. 6A illustrates a graphic that provides the effective diameter (D_{eff}) determined by DLS of alkaline-treated USY zeolites as a function of the amount of NaOH used per amount of zeolite (m_{b,total}/mₛ), according to the state of the art (squares) and the invention (circles).

FIG. 6B illustrates a graphic that provides filtration time (t_{F}) of alkaline-treated USY zeolites as a function of the effective diameter (D_{eff}) determined by DLS, according to the state of the art and the invention.

FIG. 7A demonstrates a general process overview according to an embodiment of the invention. A total mass of solid mₛ is added to water. A total mass of base m_{b,total} is added, wherein:
x=number of base additions during a treatment
z=number of treatments (for example equal to 1)
m_{b}=mass of base added per addition
m_{b,total}=total mass of base to react with the solid
mₛ=m_{s,total}=total mass of solid to react with the base
C=a constant

FIG. 7B demonstrates the maximum amount of base (m_{b,max}) in contact with the porous solid (mₛ) at any time (t) during the treatment of the total amount of base (m_{b,total}) to be contacted with mₛ. In the state of the art, the zeolite is in one step added to the alkaline solution, yielding a theoretical m_{b,max}/mₛ equal to m_{b,total}/mₛ. However, the zeolite is not instantly homogenously suspended in the alkaline solution. Accordingly, the experimental m_{b,max}/mₛ values are substantially exceeding m_{b,total}/mₛ. By adding the base gradually to a zeolite-containing watery solution, according to embodiments of the invention, the theoretical values of m_{b,max}/mₛ become substantially smaller compared to m_{b,total}/mₛ. In addition, as in this fashion the base slowly homogenously dissolves into the zeolite suspension, the experimental m_{b,max}/mₛ values are even lower compared to the theoretical ones.

FIG. 8A-D illustrate the effects of the alkaline treatments on the mesopore volume (Vₘₑₛₒ), Brønsted acidity, crystallinity, and micropore volume (V_{micro}) according to the state of the art (SA) and the invention (IP).

FIG. 9A-C illustrate the impact on the intrinsic zeolitic properties as a function of the desired introduction of secondary porosity (Vₘₑₛₒ) using state of the art (SA) or inventive technology (IP).

FIG. 10 illustrates the cavitation of mesoporosity after introduction of secondary porosity (Vₘₑₛₒ) using state of the art (SA) or inventive (IP) base leaching techniques.

FIG. 11 illustrates the BJH mesopore distributions derived from the nitrogen adsorption isotherms of a standard non-treated ZSM-5 (parent), and derived ZSM-5 zeolites which have been contacted with base accordingly to comparative example 11 (SA) and example 22 (IP). The pore width is indicated using a logarithmic scale.

### DETAILED DESCRIPTION

The following Detailed Description is merely exemplary in nature and is not intended to limit the invention or the application and uses of the invention. Furthermore, there is no intention to be bound by any theory presented in the preceding Background of the Invention or the following Detailed Description.

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

Several documents are cited throughout the text of this specification. Each of the documents herein (including any manufacturer's specifications, instructions etc.) are hereby incorporated by reference; however, there is no admission that any document cited is indeed prior art of the present invention.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to the devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Other embodiments of the invention will be apparent to those skilled in the art from consideration of the specification and practice of the invention disclosed herein.

It is intended that the specification and examples be considered as exemplary only.

Each and every claim is incorporated into the specification as an embodiment of the present invention. Thus, the claims are part of the description and are a further description and are in addition to the preferred embodiments of the present invention. Each of the claims set out a particular embodiment of the invention.

Particular and preferred aspects of the invention are set out in the accompanying independent and dependent claims. Features from the dependent claims may be combined with features of the independent claims and with features of other dependent claims as appropriate and not merely as explicitly set out in the claims.

Thus, the claims following the detailed description are hereby expressly incorporated into this detailed description, with each claim standing on its own as a separate embodiment of this invention.

The following terms are provided solely to aid in the understanding of the invention.

The term “room temperature” as used in this application means a temperature in the range of 12 to 30 deg. C., preferably in the range of 16 to 28 deg. C., more preferably in the range of 17 to 25 deg. C. and most preferably is roughly 20 to 23 deg. C.

The term “molecular sieve” as used herein refers to a solid with pores the size of molecules. It includes but is not limited to microporous and mesoporous materials, AlPOs and (synthetic) zeolites, pillared or non-pillared clays, clathrasils, clathrates, carbon molecular sieves, mesoporous silica, silica-alumina (for example, of the MCM-41-type, with an ordered pore system), microporous titanosilicates such as ETS-10, urea and related host substances, porous metal oxides. Molecular sieves can have multimodal pore size distribution, also referred to as ordered ultramicropores (typically less than 0.7 nm), supermicropores (typically in the range of about 0.7-2 nm) or mesopores (typically in the range of about 2 nm-50 nm).

A particular type of molecular sieve envisaged within the present invention are the silica molecular sieves, more particularly silica zeogrids, zeolites, and/or amorphous microporous silica materials. Among solid substances known thus far, those having uniform channels, such as zeolites represented by porous crystalline aluminium silicates and porous crystalline aluminium phosphates (AIPO) are defined as molecular sieves, because they selectively adsorb molecules smaller than the size of the channel entrance or they allow molecules to pass through the channel. In view of crystallography, zeolites are fully crystalline substances, in which atoms and channels are arranged in complete regularity. These fully crystalline molecular sieves are obtained naturally or synthesized through hydrothermal reactions. The number of fully crystalline molecular sieves obtained or synthesized thus far amounts to several hundreds of species. They play an important role as catalysts or supports in modern chemical industries by virtue of their characteristics including selective adsorption, acidity and ion exchangeability. Molecular sieves, both natural and synthetic, include a wide variety of positive ion-containing crystalline silicates. These silicates can be described as a rigid three-dimensional framework of SiO₄ and Periodic Table Group 13 element oxide, e.g. AlO₄, in which tetrahedra are crosslinked by the sharing of oxygen atoms whereby the ratio of the total Group 13 and Group 14, e.g. silicon, atoms to oxygen atoms is 1:2. Crystalline microporous silicon dioxide polymorphs represent compositional end members of these compositional material families. These silica molecular sieves do not have cation exchange capacity.

A “zeolite” can be defined as a crystalline material of which the chemical composition includes essentially aluminium, silicon and oxygen. Typically, zeolites are described as aluminosilicates with a three dimensional framework and molecular sized pores. Zeolites, both natural and synthetic, have been demonstrated in the past to have catalytic properties for various types of hydrocarbon conversion. Certain zeolitic materials are ordered, porous crystalline aluminosilicates having a definite crystalline structure as determined by X-ray diffraction, within which there are a large number of smaller cavities which may be interconnected by a number of still smaller channels or windows. These cavities and pores are uniform in size within a specific zeolite material. Since the dimensions of these pores are such as to accept for adsorption molecules of certain dimensions while rejecting those of larger dimensions, these materials are known as “molecular sieves” and are utilized in a variety of ways to take advantage of these properties. The term zeolite, as used in disclosing the present invention, can also mean means any member of a group, of structured aluminosilicate minerals comprising cations such as sodium and calcium or, less commonly, barium, beryllium, lithium, potassium, magnesium and strontium; characterized by the equation, HₓAlₓSi₁₋ₓO₂, where H can be replaced by any other univalent cation, or (when the x related to H is divided by the valence) a multivalent cation. The term zeolite also refers to an open tetrahedral framework structure capable of ion exchange, and loosely held water molecules, that allow reversible dehydration. The term “zeolite” also includes “zeolite-related materials” or “zeotypes” which are prepared by replacing Si4+ or Al3+ with other elements as in the case of aluminophosphates (e.g., MeAPO, SAPO, ELAPO, MeAPSO, and ELAPSO), gallophosphates, zincophosphates, titanosilicates, etc. The zeolite can be a crystalline porous material with a frame work as described in US2013/0118954 or provided in the Zeolite Framework Types database of the IZA structure commission where under the following structure types (from which also the framework density can be derived), as defined by the International Zeolite Association such as ABW type, ACO type, AEI type, AEL type, AEN type, AET type, AFG AFI type, AFN type, AFO type, AFR type, AFS type, AFT type, AFX type, AFY type, AHT type, ANA type, APC type, APD type, AST type, ASV type, ATN type, ATO type, ATS type, ATT type, ATV type, AWO type, AWW type, BCT type, BEA type, BEC type, BIK type, BOG type, BPH type, BRE type, CAN type, CAS type, CDO type, CFI type, CGF type, CGS type, CHA type, CHI type, CLO type, CON type, CZP type, DAC type, DDR type, DFO type, DFT type, DOH type, DON type, EAB type, EDI type, EMT type, EON type, EPI type, ERI type, ESV type, ETR type, EUO type, EZT type, FAR type, FAU type, FER type, FRA type, GIS type, GIU type, GME type, GON type, GOO type, HEU type, IFR type, IHW type, IMF type, ISV type, ITE type, ITH type, ITW type, IWR type, IWV type, IWW type, JBW type, KFI type, LAU type, LEV type, LIO type, LIT type, LOS type, LOV type, LTA type, LTL type, LTN type, MAR type, MAZ type, MEI type, MEL type, MEP type, MER type, MFI type, MFS type, MON type, MOR type, MOZ type, MSE type, MSO type, MTF type, MTN type, MTT type, MTW type, MWW type, NAB type, NAT type, NES type, NON type, NPO type, NSI type, OBW type, OFF type, OSI type, OSO type, OWE type, PAR type, PAU type, PHI type, PON type, RHO type, RON type, RRO type, RSN type, RTE type, RTH type, RUT type, RWR type, RWY type, SAO type, SAS type, SAT type, SAV type, SBE type, SBN type, SBS type, SBT type, SFE type, SFF type, SFG type, SFH type, SFN type, SFO type, SGT type, SIV type, SOD type, SOS type, SSF type, SSY type, STF type, STI type, STO type, STT type, SZR type, TER type, THO type, TOL type, TON type, TSC type, TUN type, UEI type, UFI type, UOZ type, USI type, UTL type, VET type, VFI type, VNI type, VSV type, WEI type, WEN type, YUG type and ZON type. The term “zeolite” also includes “zeolite-related materials” or “zeotypes” which are prepared by replacing Si4+ or Al3+ with other elements as in the case of aluminophosphates (e.g., MeAPO, AIPO, SAPO, EIAPO, MeAPSO, and EIAPSO), gallophosphates, zincophosphates, titanosilicates, etc.

Generally, porous substances are divided by pore size, for example, pore sizes smaller than 2 nm classified as microporous substances, between 2 and 50 nm classified as mesoporous substances and larger than 50 nm classified as macroporous substances. Non-zeolitic mesoporous silicas, such as MCM-41 and SBA-15, can display substantial microporosity. This type of microporosity is however ‘non-ordered’ and not well-defined, and should not be considered zeolitic. The microporosity as defined within the embodiments of this contribution is derived primarily from the zeolitic micropores related to the framework topologies. For example, for the USY zeolites with faujasite topology the microporosity is derived from the well-defined 0.74 nm micropores, for zeolite beta with BEA topology the microporosity stems from the well-defined 0.6 nm pores, and for zeolite ZSM-5 with MFI topology the microporosity stems from the well-defined 0.55 nm pores.

Of the porous substances, those having uniform channels, such as zeolite, are defined as molecular sieves. Up to hundreds of types of species have been found and synthesised thus far. Zeolites play an important role as catalysts or carriers in modern chemical industries by virtue of their characteristics including selective adsorptivity, acidity and ion exchangeability.

A series of ordered mesoporous materials, including MCM-41 and MCM-48, was reported in U.S. Pat. Nos. 5,057,296 and 5,102,643. These ordered materials show a structure in which mesopores uniform in size are arranged regularly. MCM-41, has a uniform structure exhibiting hexagonal arrangement of straight mesopores, such as honeycomb, and has a specific surface area of about 1000 m²/g as measured by ordinary BET. Existing molecular sieves have been produced by using inorganic or organic cations as templates, whereas those ordered mesoporous materials are synthesized through a liquid crystal template pathway by using surfactants as templates. These ordered mesoporous materials have the advantage that their pore sizes can be adjusted in a range of 1.6 nm to 10 nm by controlling the kinds of surfactants or synthesis conditions employed during the production process. Ordered mesoporous materials designated as SBA-1,-2 and 3 were reported in Science (1995) 268:1324. Their channels are regularly arranged, while the constituent atoms show an arrangement similar to that of amorphous silica. Ordered mesoporous materials have regularly arranged channels larger than those of existing zeolites, thus enabling their application to adsorption, isolation or catalytic conversion reactions of relatively large molecules.

In general, the present invention concerns a process of controlled treatment of alkaline treatment to treat inorganic porous solids, for instance crystalline solid particles, without a negative influence on the particle or crystal size, and to obtain an end product of solids with superior physico-chemical and catalytic properties. The process of the present invention may yield solids which are easily recovered from the alkaline solution after treatment. In a particular embodiment the process comprises the stepwise contacting of the solid to the base, hereby largely preventing fragmentation. As a result, particle and crystal pore sizes may be obtained which are more similar to the starting solid. In addition to the superior physico-chemical properties, superior catalytic properties, and the enhanced filtration behaviour, this invention may enable to reduce the amount of organics required in order to preserve the microporosity, crystallinity, and acidity during the alkaline leaching.

As used herein, the term “Al in the framework” refers to tetrahedral coordinated Al.

Within the examples on multiple occasions reference is made to the filtration time, defined as ‘t_{F}’. It is to be understood that this quantity refers to the time it takes to separate a solid from 97 vol. % of the alkaline solution using standard Buchner filtration. More specifically, this refers to filtration of the solid suspension using a Buchner step up equipped with a paper filter (Whatman filter #4 or #5, 9 cm in diameter). The filtration time is affected by both the process conditions (reaction time, reaction temperature, solid-to-liquid ratio, amount of base, type of base, additives such as TPABr, conventional or inventive base treatment), the scale of the treatment, and the used filter (Whatman #4 or #5). Accordingly, these parameters are therefore in all examples given. Process time (t_{P}) relates to cumulative time it takes to execute the alkaline treatment and the subsequent filtration. In the case of a multistep treatment, the total treatment and filtration time is complemented with the required drying step in between the filtration and subsequent alkaline treatment.

The properties of the solids may be assessed using nitrogen adsorption at 77 K as it is a well-established technique to quantify the intrinsic zeotypical properties (relevant for crystalline microporous solids), as well as the amount of mesoporous in the solid. The first descriptor that is derived from the nitrogen isotherm is the total surface area (S_{BET}). The latter is obtained by application of the BET model, and gives an indication of the overall porosity (micropores and mesopores) of the solids. The intrinsic zeotypical properties can be examined using the microporosity (V_{micro}), which is derived from application of the t-plot to the adsorption branch of the isotherm, preferably applied within the range 0.35-0.50 nm thickness. Since the active sites (Brønsted sites, described below) are located in the micropores, it is preferred that upon alkaline post-synthetic modification the micropore volume remains as close to the starting zeolite as possible.

Nitrogen-sorption measurements were executed at −196° C. with a Micromeritics TriStar 3000 instrument, controlled by TriStar 3000 software (Micromeritics) version 6.03. Prior to the sorption experiment, the samples were degassed overnight under a flow of N₂ with heating to 300° C. (5° C. min⁻¹). The t-plot method, as described in Microporous Mesoporous Mater. 2003, 60, 1-17, was used to distinguish between micro-and mesopores (thickness range=0.35-0.50 nm, using thickness equation from Harkins and Jura, and density conversion factor =0.0015468). To accurately compare the microporosity derived from the t-plot among solids, it is preferred that the same t-plot method and thickness range and thickness equation are used. For example, if the t-plot is applied in a narrow range at high relative pressures (for example at p/p₀=0.30-0.35) the resulting microporosity can be an overestimation. The t-plot method simultaneously yields an external surface (referred to ‘Sₘₑₛₒ’) which is used as an indication for the degree of secondary porosity.

For the pore size distribution, the BJH model, as also described in Microporous Mesoporous Mater. 2003, 60, 1-17 was applied to the adsorption branch of the isotherm. The total pore volume (Vₚₒᵣₑ) was determined at relative pressure (p/p₀=0.98). The mesopore volume (Vₘₑₛₒ) is defined as Vₘₑₛₒ=Vₚₒᵣₑ−V_{micro}. The occlusion or cavitation ratio is defined as the ratio of the slopes of the points measured at the adsorption- and the desorption-branch (slope_{ads}/slope_{des}) between relative pressures p/p₀ of 0.82 and 0.87 of the nitrogen isotherms. The further away the desorption branch deviates from the adsorption branch, the higher the ratio becomes. Therefore high hysteresis/occlusion can be related to a high cavitation ratio, which is unfavourable in catalytic applications. It is therefore desired that the cavitation ratio is as small as possible.

In the case the inorganic porous solids are crystalline, zeolites, SAPOs, AlPOs, the preservation of the intrinsic properties can be examined using X-ray diffraction (XRD). This technique results in a topology-specific reflection pattern. The relative crystallinity, indicative for the overall intrinsic zeotypical properties, can be assessed by integration of several characteristic peaks using methods such as described in ASTM D3906 (for faujasite zeolites) and ASTM 5758 (for ZSM-5 zeolites). It is preferred that the alkaline-treated sample displays a crystallinity as high as possible relative to the starting crystalline inorganic solid. In the case of faujasites the relative crystallinity is compared to industrial standard NaY zeolite provided by Zeolyst (supplier code ‘CBV 100’). In addition, the relative crystallinities of the zeolites are quantified by comparison to a NIST standard alumina (SRM 676). This is achieved by comparing the area of the peak at 25.7 degrees 2theta of the NIST standard to the area of the peak at 15.7 degrees 2theta for zeolites with FAU topology, or to the area of the peak at 7.7 degrees 2theta for zeolites with the BEA topology, or the area of the peaks in the range from 23.1 to 24.3 degrees 2theta for ZSM-5 zeolites. XRD is also a useful characterization technique as it enables to determine the unit cell size. Particularly in the case of faujasites, the unit cell size is relevant as it gives an indication of the composition (atomic Si/Al ratio) of the framework. The unit cell size is derived using established methods as specified in ASTM 3942. X-Ray diffraction was measured on a Siemens D5000 diffractometer with Bragg-Brentano geometry and Ni-filtered Cu Kα radiation (λ=0.1541 nm). Data were recorded in the range 5-50 degrees 2theta with an angular step size of 0.05 degrees and a counting time of 8 s per step.

Another method to monitor the influence of a post-synthetic treatment is by means of magic angle scanning nuclear magnetic resonance (MAS NMR) spectroscopy. This technique probes the coordination of the T-atoms (Al and Si). In the case of aluminium, it is generally assumed that zeolitic framework tetrahedrally-coordinated species occur in the range of 40 ppm to 80 ppm, whereas partly-framework pentahedrally-coordinated species occur in the 10 ppm to 40 ppm range, and extra-framework octahedrally-coordinated species occur in the range 10 ppm to −40 ppm (Angewandte Chemie, 1983, 22, 259-336). It is accordingly important that, to attain the highest degree of zeolitic properties during post-synthetic modifications, the relative amount of tetrahedrally-coordinated species are highest. In the case of silicon coordination, the MAS NMR technique enables to assess the number of Al atoms the average Si atom is coordinated with (Angewandte Chemie, 1983, 22, 259-336). This varies from 0 (no Al neighbours, indicated as ‘Si (0Al)’) to a full coordination of Al (4 Al neighbours, indicated as ‘Si (4Al)’). In the alkaline treatment of USY zeolites it is most favourable to maintain the highest amount of Si (OAl) species as in this manner the desired hydrothermal stability of the framework is preserved.

Experimental: ²⁹Si and ²⁷Al magic-angle spinning (MAS) NMR spectra were acquired on Bruker Avance III 400 and 700 MHz spectrometers operating at 9.4 and 16.4 T, respectively, and ²⁹Si and ²⁷Al Larmor frequencies of 139.1 and 182.4 MHZ, respectively. All samples were packed into 4 mm (²⁷Al) and 7 mm (²⁹Si) ZrO₂ rotors. ²⁹Si MAS NMR spectra were recorded in a double resonance probe at a spinning rate of 5 kHz using a pulse width (45° flip angle) of 3.4 μs, corresponding to a radio-frequency (rf) field strength of ˜37 kHz. The recycle delay was set to 60 s and a number of scans between 500 and 1000 was employed in all samples. ²⁷Al MAS NMR spectra were recorded in a double resonance probe at a spinning rate of 14 kHz. Quantitative spectra were obtained using a π/18 short rf pulse (˜0.3 μs) calibrated using an aqueous solution of Al(NO₃)₃, corresponding to an rf field strength of 104 kHz. The recycle delay was set to 1 s and a number of scans between 9 k and 15 k was employed in all samples. Chemical shifts are quoted in ppm from octakis (trimethylsiloxy) silsesquioxane (−109.68 ppm, for the farthest downfield frequency peak) and aqueous solution of Al(NO₃)₃ (0 ppm) for ²⁹Si and ²⁷Al, respectively.

The majority of applications of the inorganic porous solids described herein comprise acid-catalysed conversions. Herein, the acid-site type and quantity is crucial. To quantitatively monitor the acidic properties of solids, a routinely-applied technique is the Fourier-transform infrared (FTIR) spectroscopy of pyridine adsorbed onto the solids. This method enables to quantify the number of strong Brønsted sites (B) and weaker Lewis acid sites (L) present within the solid. In catalytic applications of zeolites and SAPOs, particularly the amount of Brønsted acid sites, are key to their effective operation. Since the main goal of the modification by alkaline treatment is porous enhancement, it is imperative that particularly the Brønsted site density is maintained upon alkaline treatment. In addition, the Brønsted acidity can be measured using temperature programmed desorption of NH₃-TPD.

Pyridine FTIR measurements were performed by using a Nicolet 6700 spectrometer equipped with a DTGS detector. Samples were pressed into self-supporting wafers and degassed at 400° C. for 1 h in vacuo before measurements. Brønsted and Lewis acid sites were analysed by using a pyridine probe. After evacuation, the samples were subjected to 4-5 pulses of at least 25 mbar of pyridine at 50° C. for 1 min (until saturation), after which the system was heated to 150° C. in 40 min, followed by the acquisition of the spectra at the same temperature. The absorptions at 1550 and 1450 cm⁻¹ corresponded to the amount of Brønsted and Lewis acid sites, respectively. The extinction coefficients were determined by Emeis, J. Catal. 1993, 141, 347-354.

NH₃ temperature-programmed desorption (TPD) signals of the solids were attained using a custom set-up in which 100 mg of the sample was first pre-treated at 400° C. under He (20 cm³ min⁻¹) for 1 h (ramp 10° C. min⁻¹). Next 5% NH₃ in He (20 cm³ min⁻¹) was adsorbed at 200°° C. for 30 min followed by purging with He for 30 min at the same temperature (20 cm³ min⁻¹). The desorption was monitored on a Pfeiffer Omnistar quadrupole mass spectrometer in a range from 200-700° C. (10° C. min⁻¹) under He flow (10 cm³ min⁻¹).

The catalytic performance was monitored in the isomerization of α-pinene, as it represents a suitable model reaction in which both the function of the intrinsic zeotypical properties and that of the external surface is probed. In this reaction the activity (A) refers to the degree of conversion, while the productivity (P) is the yield of useful products (limonene, camphene, α-terpinene, γ-terpinene, terpinoline, p-cymene). The P/A ratio enables to compare selectivities: higher P/A values indicate lower amounts of unwanted side products such as cokes (polymers and oligomers of α-pinene). The value P/Vₘₑₛₒ relates the productivity to the secondary porosity. It is accordingly a measure for the efficiency of the secondary porosity.

Experimental catalysis: The isomerization reactions were carried out in a 50 cm³ Parr reactor with a sampling device at 150° C. under 6-8 bar of nitrogen with a stirring speed of 750 rpm. A mixture of substrate (20 g; a-pinene) and catalyst (0.1 g) was heated to 100° C., after which time the first liquid sample was taken. The reaction mixture was then further heated to 150° C. and more samples were taken 10, 30, and 60 min after the first sample. The samples were then analysed on a gas chromatograph (HP 5890, Hewlett Packard) equipped with an HP1 column and a flame ionization detector (FID). Tetradecane was used as an external standard. Unidentified products were analysed by GC-MS (6890N, Agilent Technologies). The activity of the samples was determined by using the slope of the linear part of the conversion of a-pinene versus the contact time graph.

Besides the physical chemical properties and associated catalytic performance, the recoverability of zeolites from aqueous solutions is a key descriptor to the economic viability of solids, especially those prepared (and modified) in aqueous solutions. Therefore, when applying post-synthetic modifications in aqueous solutions, such as alkaline treatment, it is imperative that, besides the desired physico-chemical enhancements, the particle size distribution is not negatively influenced. Thus far, the implication of alkaline treatments on the particle and crystal size distribution, and associated recoverability, are not known in the state of the art. The inventors have found that alkaline treatments on porous inorganic solids, such as zeolites, SAPOs, AlPOs, and ordered mesoporous materials such as MCM-41 and SBA-15, have a severe influence on the particle and crystal size of the inorganic solid. The alkaline treatments strongly lower the average particle and crystal size, complicating their recoverability. As a result, the filtration of inorganic porous solids using membrane-based techniques, such as Buchner set-ups, can take up to 100 times more time. The latter is economically rather unattractive and limits the commercial potential of alkaline-treated zeolites of the prior art.

Particle size measurements were performed by putting part of the suspension obtained after alkaline treatment in a standard polystyrene cuvette (2.5 ml) and subjecting them to dynamic light scattering (DLS) analysis. Accordingly, the supernatant of the centrifuged (15 min at 12,000 rpm) suspension was measured in polystyrene cuvettes on a 90Plus Particle Size Analyzer (Brookhaven) equipped with 659 nm laser, under a detection angle of 90°. Fluctuations in the scattered light intensity were correlated between 10 ms and 5 s. Correlation functions were analysed with Igor Pro 6.2, using the Clementine package for modelling of decay kinetics based on the Maximum Entropy method. The decay time was converted to a hydrodynamic diameters using the Stokes-Einstein equation. The resulting criterion for size is expressed as the effective diameter (D_{eff}), which represents a weighted average of the hydrodynamic diameter of the particles in the sample. These are calculated from the measured diffusion coefficient by DLS.

According to a first aspect, the invention relates to a method for preparing a treated inorganic porous solid wherein the method comprises a number of separate treatments (z) which are separated by a solid separation step, such as a filtration step, each of the z treatments comprising the steps of:
a) providing an inorganic porous solid, at an amount of mₛ;
b) providing a total amount of base m_{b,total}; and,
c) contacting and reacting the inorganic porous solid with an amount of base m_{b}(t) in a
solution over a time frame Δt for the total amount of base m_{b,total};

thereby obtaining a treated inorganic porous solid;

wherein the maximum amount of base m_{b,max} of m_{b}(t) brought into contact with inorganic porous solid mₛ at any given time t in step c) is smaller than m_{b,total}/mₛ. The total amount of base can be provided in the form of a solid alkali or an alkaline solution, preferably an alkaline solution.

In some preferred embodiments, the process comprises a method for preparing a treated inorganic porous solid, wherein the method comprises a single treatment (z=1) comprising the steps of:
a) providing an inorganic porous solid, at an amount of mₛ;
b) providing a total amount of base m_{b,total}; and,
c) contacting and reacting the inorganic porous solid with an amount of base m_{b}(t) in a solution over a time frame Δt for the total amount of base m_{b,total};

thereby obtaining a treated inorganic porous solid;

wherein the maximum amount of base m_{b,max} of m_{b}(t) brought into contact with inorganic porous solid mₛ at any given time t in step c) is smaller than m_{b,total}/mₛ. The total amount of base can be provided in the form of a solid alkali or an alkaline solution, preferably an alkaline solution.

In some embodiments, the process comprises the stepwise contacting of the solid to the base, hereby largely preventing fragmentation. As a result, particle and crystal pore sizes may be obtained which are similar to the starting solid.

In addition to the superior physico-chemical properties, superior catalytic properties, and the enhanced filtration behaviour, this invention enables to reduce the amount of organics required in order to preserve the microporosity and crystallinity during the alkaline leaching.

The ratio m_{b,max}/mₛ may be considered to be the maximum amount of base brought into contact with the solid at any time. In the state of the art (where y, x, z=1), the time of adding the base to the solvent during a treatment (t_{mb}) is before the time of adding the inorganic porous solid (tₘₛ) to the solvent during the same treatment is added. Hence in the state of the art t_{mb}<tₘₛ. The zeolite powder takes several minutes to be suspended in an aqueous solution. This implies that when the zeolite is added after the base (t_{mb}<tₘₛ), the initially suspended zeolite fraction is exposed to the entire base quantity, whereby m_{b,max}/mₛ>>m_{b,total}/mₛ.

In some preferred embodiments, the maximum amount of base m_{b,max} of m_{b}(t) at any given time t in step c) is at most than 0.75*m_{b,total}, preferably at most than 0.50*m_{b}, total, preferably at most than 0.25*m_{b, total}.

In some preferred embodiments, the inorganic porous solid comprises a molecular sieve, such as a zeolite or SAPO.

In some embodiments, the inorganic porous solid is a zeolitic material, preferably of structure type MWW, BEA, MFI, CHA, MOR, MTW, RUB, LEV, FER, MEL, RTH AEL, AFI, CHA, DON, EMT, CFI, CLO, TON, FER, ERI, MEL, MTW, MWW, HEU, EUO, RHO, LTL, LTA, MAZ, and most preferably to MOR, MFI, BEA, FAU topology, this zeolitic material having a mesoporosity after the treatment. This method or process can start from crystalline silicates, in particular those having zeolitic structure, which are subjected to an alkaline treatment and the new material with zeolitic properties and with mesoporosity is obtainable without high-speed commercial centrifuges or omitting filtration steps in between sequences of treatments. These zeolitic materials with mesoporosity may thereby be prepared in an ecologically and economically advantageous manner.

In some embodiments, this method or process can start from an amorphous silicate, such as fumed silica, and/or ordered silicas such as MCM-41 or SBA-15.

In some preferred embodiments, step a) comprises:
a′) providing the inorganic porous solid at an amount of mₛ suspended in a solution, preferably in water.

Preferably the solvent is water. In some embodiments, other solvents are used, such as alcohols (methanol, ethanol, or isopropanol). Typical solutions are in water with pH varying from at least 10 to at most 14, which relates to concentrations of NaOH of 0.0001 M to 1 M. The solid-to-liquid ratio (inorganic porous solid to liquid of base) can vary from very low 1 g L⁻¹ to very high 100 g L⁻¹, but in the examples is typically chosen to be typically 33 g L⁻¹. The temperature may range from at least room temperature to at most 100° C., preferably from at least 50° C. to at most 70°° C.

By adding the base to a suspension of zeolite, for example in water (tₘb>tₘₛ), the non-instantaneous mixing/dissolution of the base implies that the initial value of m_{b,max}/mₛ<m_{b,total}/mₛ.

In some embodiments, the base is added in multiple discrete steps. The inorganic porous solid is not separated in between these steps. In some preferred embodiments, the method comprises a number of base additions per treatment (x) which are not separated by a solid separation step, and an amount of base added per addition (m_{b,i} with i=1 . . . x), characterised in that x is not equal to 1, preferably wherein x is at least 2, preferably at least 3, preferably at least 4.

In some preferred embodiments, z is 1. This means that there is only one treatment, followed by a solid separation step, preferably a filtration step. During this treatment, the base is added in multiple steps (x≠1), or gradually. In some preferred embodiments, z is more than 1, for example at least 2, at least 3, or at least 4.

In some embodiments, the base is added gradually or continuously. The inorganic porous solid is not separated during this gradual addition. In some preferred embodiments, the rate of adding the amount of base over time is at most 3.0 mmol g⁻¹ min-1, preferably at most 1.0 mmol g⁻¹ min⁻¹, preferably at most 0.5 mmol g⁻¹ min⁻¹.

The rate of adding the amount of base over time may depend on the used treatment. However, very good solids can be obtained by keeping this value below 3.0 mmol of base per gram of zeolite per minute (mmol g⁻¹ min⁻¹), preferably below 1.0 mmol g⁻¹ min⁻¹, and most preferably below 0.5 mmol g⁻¹ min⁻¹.

The base addition rate as mentioned in some of the examples may be scale sensitive as it is not normalized to the zeolite quantity. This could be normalized to a unit expressed in mol of base per gram of zeolite per hour. In some embodiments, for example as demonstrated in Example 17 (3.3 g zeolite in 90 ml solvent, to which 10 ml of 2 M NaOH is added using the syringe pump), the suitable range is 5-150 ml h⁻¹, preferred range 10-50 ml h 1, and most preferred 15-30 ml h⁻¹.

In some preferred embodiments, the base is continuously added to the inorganic porous solid during a time frame Δt, wherein the time frame Δt for adding the total amount of base m_{b,total} is at least 15 s, preferably at least 30 s, for example at least 60 s, for example at least 2 min, for example at least 4 min, for example at least 8 min, for example at least 15 min, for example about 30 min. In some embodiments, Δt is at least 8 min and at most 60 min, preferably at least 15 min and at most 45 min, for example about 30 min.

In some preferred embodiments, the method is followed by a sequential acid treatment. This has the advantage that it enhances mesopore surface and volume, micropore volume, crystallinity, and acidity in a superior fashion than when applied in the state of the art.

In some embodiments, additives can be added, like the base in above-described fashion, in similar gradual fashion. Such additives can be metal salts, such as Al(NO₃)₃ and Ga(NO₃)₃, and organic compounds such as TPABr.

The impact of the invention, as compared to the state of the art, may depend on the nature of the samples. Among others, the largest influence may be the density of the zeolite's framework topology. In this case, a lower topological density yields a larger advantage. Therefore, the benefits on the zeolites with the FAU framework (density 13.3 T-atoms/1000 Å³), are larger compared to those obtained on zeolites with BEA framework (density 15.3 T-atoms/1000 Å³). Similarly, the benefits on BEA may therefore be larger compared to zeolites of the MFI framework (18.4 T-atoms/1000 Å³).

In addition, in the case of zeolites, the Si/Al ratio in the framework (and bulk) may have an influence. For example, in the case of preventing fragmentation and associated prolonged filtration times, the effect is optimal when the atomic Si/Al ratio is 5 or higher, preferably 10 or higher, and most preferably 20 and higher. This is demonstrated in Table A, where the filtration time of alkaline-treated USY zeolites increases rapidly with an increase of the Si/Al ratio of the starting zeolite.

In some embodiments, the invention comprises a process to perform alkaline treatment on inorganic porous solids yielding superior physico-chemical and catalytic properties, without a negative influence (or with only a limited influence) on the particle or crystal size. The application of the invention yields solids which may be easily recovered from the alkaline solution after treatment. In some embodiments, the process comprises the stepwise contacting of the solid to the base, hereby largely preventing fragmentation. As a result, particle and crystal pore sizes are obtained which are similar to the starting solid. In addition to the superior physico-chemical properties, superior catalytic properties, and the enhanced filtration behaviour, this invention enables to reduce the amount of organics required in order to preserve the microporosity and crystallinity during the alkaline leaching.

As illustrated by various examples, the inventive process can performed by multiple treatments of lower alkalinity, by dosing the base stepwise during the alkaline treatment, or by pumping a dilute alkaline solution through a solid-containing membrane. After such treatments, filtration time may be reduced substantially, thereby enhancing the overall productivity of the leaching process.

In some embodiments, afterwards, the reactor is quenched, the solid filtered off (using a lab-scale Buchner set-up), and washed. FIG. 1 depicts a general process overview wherein conventionally first a base is added, after which the porous solid is added and left to react under vigorous mechanical stirring. In FIG. 1, x represents the number of base additions per reaction, m_{b} the amount of base added per addition, y the number of solid additions per reaction, mₛ the amount of solid added per addition, and z represents the number of treatments. In the state of the art, x, y, and z are equal to 1. In the further embodiments in this detailed description, y, and mₛ are not modified.

In order to highlight the value of the invention, it is essential to describe the state of the art in the experimental procedures of alkaline leaching of solids. In the state of the art, a fixed amount of porous solid (typically 33 g L⁻¹), is contacted with an aqueous solution with a fixed alkalinity. This is achieved by a direct immersion of the solid in a heated alkaline solution (typically using NaOH, at 0.24 m_{b,total}/mₛ, at 65° C.), after which it is left to react (typically for 30 min).

In some embodiments, the alkaline treatment is executed exactly as in the state of the art, for example as described above, with the exception than the alkalinity is reduced, and the treatment is repeated to achieve the desired effect of the leaching. This could be, for example, that instead of one reaction 0.24 m_{b,total}/mₛ, two reactions of 0.12 m_{b,total}/mₛ are executed. The inventors have found that the filtration time of these two treatments combined can be significantly shorter than the filtration time following the single direct treatment at higher concentration. In FIG. 1., the difference between the state of the art is x being equal to 1 whereas z is 2 (or higher). In addition, x*m_{b}*z is similar in the invention and the state of the art. This implies that the same overall amount of base is contacted with the porous solid, which comes recommended to ensure the desired effect of the leaching.

In some embodiments, the base is added, as solid or highly concentrated form, slowly during the course of the treatment. The inventors have found that this can be easily achieved using a pump, such as a syringe or peristaltic pump. On larger scales industrial pumps or solid dispersers may be used. This approach has as advantage that only one treatment is required, while acquiring the same significantly reduced filtration times. Particularly in this embodiment, the efficiency of the use of TPABr or DEA to preserve the intrinsic zeolitic properties is greatly enhanced. The invention goes beyond the state of the art based on several arguments. First, the solid is added prior to the addition of the base. Secondly (see FIG. 1), z is equal to 1, whereas x is 2 (or higher). Keeping x*m_{b} constant ensures that the same amount of base is reacted with the solid.

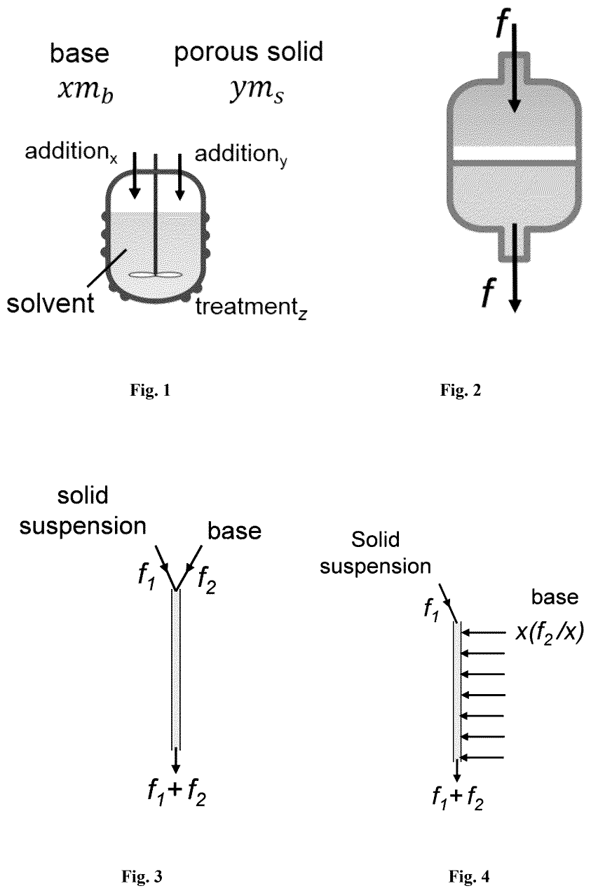

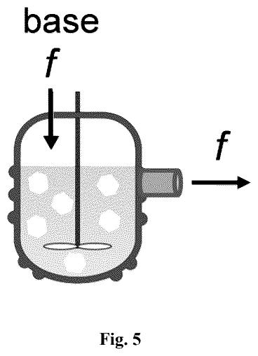

In some embodiments, the method comprises the stepwise contacting of a solid to a base using continuous configuration. In this configuration, the porous solid can be located on a membrane and the (dilute) basic solution is contacted to it by flowing (f) it through the solid-covered membrane (FIG. 2). On a lab scale such experiment may be performed using a continuous microfiltration set-up. This configuration holds no resemblance to the in-line synthesis as known (FIG. 3), as in that work the base is pumped together with the solid, hence enabling it to react as in a plug flow, which yields the same materials as a batch reactor used in the prior art. However, if in the inline set up, the base is added stepwise in the line (FIG. 4), the solid and base no longer react as a batch reactor. Instead, it acts as described for the innovative process: the solid is stepwise contacted with the base, yielding superior solids. In addition, the base can be contacted with the zeolite in a continuous stirred-tank reactor (FIG. 5), or any other configuration that enables a gradual or stepwise contacting of the solid with the base.

In a second aspect, the invention relates to an inorganic porous solid obtainable by the method according to the first aspect, or any embodiment thereof. Preferred embodiments of these treated inorganic porous solids are as defined above.

In a third aspect, the invention relates to a zeolite with the faujasite topology, preferably prepared according to the method of the first aspect or any embodiment thereof, with a unit cell size ranging from 24.375 Å to 24.300 Å with a mesopore volume of at least 0.35 ml/g. Typically, the unit cell gets smaller when framework Al is removed. This type of zeolite is commonly referred to as an USY-I zeolite.

In some preferred embodiments, the zeolite according to the third aspect has a Brønsted acidity of at least 400 μmol g⁻¹, as measured with pyridine; preferably 425 μmol g⁻¹ or higher, and most preferably 500 μmol g⁻¹ or higher, as measured with pyridine.

In some preferred embodiments, the zeolite according to the third aspect has a fraction of Al in the framework of at least 0.5, preferably 0.55 or higher, and most preferably 0.60 or higher.

In some preferred embodiments, the zeolite according to the third aspect has a crystallinity of at least 70%, preferably 75% or higher, and most preferably 80% or higher, relative to a standard NaY zeolite, and at least 80%, preferably 90% or higher, and most preferably 100% or higher, compared to NIST standard alumina (SRM 676).

In some preferred embodiments, the zeolite according to the third aspect has a microporosity of at least 0.18 ml g⁻¹, preferably 0.21 ml g⁻¹ or higher, and most preferably 0.24 ml g⁻¹ and higher.

In a fourth aspect, the invention relates to a zeolite with the faujasite topology, preferably prepared according to the method of the first aspect or any embodiment thereof, with a unit cell size of at most 24.300 Å, preferably with a mesopore volume of at least 0.35 ml g⁻¹. This type of zeolite is commonly referred to as an USY-III zeolite.

In some preferred embodiments, the zeolite according to the fourth aspect has a micropore volume of at least 0.21 ml g⁻¹, preferably 0.22 ml g⁻¹ or higher, and most preferably 0.23 ml g⁻¹ and higher.

In some preferred embodiments, the zeolite according to the fourth aspect has a crystallinity of at least 95%, preferably 100% or higher, and most preferably 105% or higher, relative to a standard NaY zeolite, and at least 130%, preferably 137% or higher, and most preferably 142% or higher, compared to NIST standard alumina (SRM 676).

In some preferred embodiments, the zeolite according to the fourth aspect has a mesopore cavitation of at most 1.6, preferably 1.5 and lower, most preferably 1.4 and lower, as measured with nitrogen adsorption.

In some preferred embodiments, the zeolite according to the fourth aspect has a particle size D_{eff} of at least 300 nm, preferably 350 nm and higher, most preferably 400 nm and higher.

In a fifth aspect, the invention relates to a zeolite with an MFI topology, preferably prepared according to the method of the first aspect or any embodiment thereof, with a molar Si/Al ratio of at most 400, with a mesopore volume of at least 0.30 ml g⁻¹ and a crystallinity of at least 330%, preferably 340% and higher, and most preferably 350% and higher, compared to NIST standard alumina (SRM 676).

In an aspect, the invention relates to a zeolite with a BEA topology, preferably prepared according to the method of the first aspect or any embodiment thereof, with a mesopore volume of at least 0.50 ml g⁻¹ and a crystallinity of at least 500%, preferably 515% and higher, and most preferably 530% and higher, compared to NIST standard alumina (SRM 676).

For industrial large-scale application, zeolite powders (as described in the examples) typically require to be transformed into technical catalysts. Technical catalysts are typically designed to provide the required mechanical strength and chemical stability to withstand demanding industrial catalytic unit operations. The transformation of a zeolite powder into a technical catalyst is preferably performed by mixing the zeolite with several other ingredients (such as fillers, pyrogens, binders, lubricants, etc.) and the subsequent shaping into macroscopic forms. The resulting technical catalysts can be multi-component bodies with sizes from the micrometres to the centimetre range.

In a sixth aspect, the invention relates to a method for preparing a technical catalyst, the method comprising the steps of:
preparing a treated inorganic porous solid according to the first aspect of the invention, and preferred embodiments thereof;
adding one or more additional ingredients to form a mixture, preferably wherein the one or more additional ingredients are selected from the group comprising: fillers, pyrogens, binders, lubricants, and combinations thereof; and
shaping the mixture into a macroscopic form to obtain a technical catalyst, preferably wherein the macroscopic form has a minimal dimension from at least 1 μm to at most 10 cm.

The inventors have found that the solids as described above, particularly those of the second, third, fourth, and fifth aspects, as well as preferred embodiments thereof, are ideal intermediate compounds for the preparation of a technical catalyst as described above.

In a seventh aspect, the invention relates to the use of a treated inorganic porous solid according to any one of the aspects described herein or prepared in a method according to any one of the aspects, and embodiments thereof, in catalysis, adsorptive or ion exchange processes. Preferred embodiments of this use are as defined above.

Some embodiments of the invention are set forth below. These embodiments are also combinable with any of the embodiments described above.

In some embodiments the invention relates to a process of alkaline leaching of a porous solid whereby the method comprises a number of base additions per reaction (x), an amount of base added per addition (m_{b}), a number of solid additions per reaction (y), an amount of solid added per addition (mₛ), a number of treatments (z), characterised in that x and z are not equal to 1, for example in that x, y, and z are not equal to 1.

In some embodiments, when x is equal to 1, z is 2 (or higher). In addition, x*m_{b}*z may be adapted to an overall amount of base contacted with the porous solid, to ensure the desired effect of the leaching but to avoid fragmentation.

In some embodiments, the process is so designed by controlling y, z or x, preferably z or x, preferably x, so that although the porous solid is subjected to a same overall amount of base or that a same overall amount of base is contacted with the porous solid (which is preferred to ensure the desired effect of the leaching), the alkaline leaching is less drastic than subjecting the porous solid of 20-40 g L⁻¹ in an aqueous solution contacted with a fixed alkalinity of 0.1 to 0.2 M NaOH, typically for about 20 to 40 min.

In some embodiments, the process is so designed that although the porous solid is subjected to a same overall amount of base by controlling y, z or x, preferably z or x, preferably x, the alkaline leaching is less drastic than subjecting porous solid of 20-40 g L⁻¹ in an aqueous solution contacted with a fixed alkalinity of 0.1 to 0.2 M NaOH, typically for about 20 to 40 min. at a temperature of 45 to 85° C.

In some embodiments, the process is so designed that although the porous solid is subjected to a same overall amount of base by controlling y, z or x, preferably z or x, preferably x, so that no fragmentation of components of the porous solid occurs.

In some embodiments, the process is so designed that although the porous solid is subjected to a same overall amount of base by controlling y, z or x, preferably z or x, preferably x, so that basically no fragmentation of components of the porous solid occurs.

In some embodiments, the porous solid is crystalline and the process is so designed that although the porous solid is subjected to a same overall amount of base by controlling y, z or x preferably z or x, preferably x, basically no crystal fragmentation occurs.

In some embodiments, the process comprises alkaline leaching on porous solid at 5 to 60 g L⁻¹, preferably 20 to 40 g L⁻¹, and whereby the process comprises subjecting the porous solid to a treatment regime several reaction of mild conditions of NaOH at a temperature between 40 to 70° C., preferably a temperature between 60 to 75° C. and a reaction time of 10 to 50 min., preferably 20 to 40 min whereby the treatment regime comprises z treatments of m_{b} amounts of NaOH to have the same amount of NaOH consumed as one treatment of 0.15 to 0.25 M NaOH.

In some embodiments, the porous solid is a porous silicate solid.

In some embodiments, the silicate solid is a material with a topology of the group consisting of MWW, BEA, MFI, CHA, MOR, MTW, RUB, LEV, FER, MEL, RTH AEL, AFI, CHA, DON, EMT, CFI, CLO, TON, FER, ERI, MEL, MTW, MWW, HEU, EUO, RHO, LTL, LTA and MAZ.

In some embodiments, the silicate solid is a material with a topology of the group consisting of MOR, MFI, BEA and FAU.

In some embodiments, the silicate solid is a porous crystalline silicate.

In some embodiments, the silicate solid is a porous crystalline silicate having zeolitic structure.

In some embodiments, the silicate solid is amorphous, such as fumed silica or silica gel.

In some embodiments, the porous solid is an amorphous alumino-silicate.

In some embodiments, the silicate solid is a porous ordered silicate (e.g. MCM-41 or SBA-15).

In some embodiments, the porous solid is an ordered alumino-silicate (e.g. MCM-41).

In some embodiments, the porous solid is a porous amorphous (silico) aluminophosphate.

In some embodiments, the porous solid is a porous crystalline (silico) aluminophosphate (e.g. AlPO-5, SAPO-11, SAPO-34).

In some preferred embodiments, the invention comprises any one the following numbered statements. These numbered statements may be combined with any other embodiment in the claims and the description. Reference to statement 1 in statements 2-43 may also be replaced by reference to the first aspect of the invention. Reference to statement 44 in statements 45-51 may also be replaced by reference to the second, third, fourth, and fifth aspect of the invention. References in statements 52-55 may also be replaced by reference to the seventh aspect of the invention.
1. A process of alkaline treatments of inorganic porous solids, characterized in the said process yields superior physico-chemical properties and superior catalytic performance, without negatively affecting the particle and crystal size distribution.
2. The process according to statement 1, characterized in that the inorganic porous solids is of the group consisting of an amorphous solid, an ordered mesoporous solid, a crystalline solid, a solid in the form of silicates, an aluminate, a phosphate, an aluminosilicate, an aluminophosphate and a silicoaluminophosphate.
3. The process according to statement 1, characterized in that the inorganic porous solids is crystalline silicoaluminophosphates.
4. The process according to statement 1, characterized in that the inorganic porous solids is crystalline aluminosilicates.
5. The process according to statement 1, characterized in that the inorganic porous material has prior to alkaline treatment, total surface areas (SBET) preferably higher than 100 m² g⁻¹, most preferably higher than 200 m² g⁻¹.
6. The process according to statement 1, characterized in that the inorganic porous solids is a zeolitic material or a porous crystalline silicate or an amorphous porous silicate
7. The process according to statement 1, characterized in that solid has a cation exchange capacity below 1 mmol g⁻¹, and most preferably below than 0.5 mmol g⁻¹.
8. The process according to statement 1, characterized in that solid has a framework densities lower than 18 T atoms nm⁻³, and most preferably below 15 T atoms nm⁻³.
9. The process according to statement 1, characterized in that solid has a external surfaces (Sₘₑₛₒ), prior to the alkaline treatment, higher than 20 m² g⁻¹, and most preferably higher than 50 m² g⁻¹.
10. The process according to statement 1, characterized in that solid has is zeolitic, and has bulk with Si/Al>10, and most preferably with Si/Al>20.
11. The process according to statement 1, characterized in that solid has a framework topology of AEL, AFI, CHA, DON, EMT, CFI, CLO, TON, FER, ERI, MEL, MTW, MWW, HEU, EUO, RHO, LTL, LTA or MAZ.
12. The process according to statement 1, characterized in that solid has a framework topology of MOR, MFI, BEA or FAU.
13. The process according to any one of the statements 1 to 12, characterized in that the base is an inorganic base
14. The process according to any one of the statements 1 to 12, characterized in that the base is an inorganic base of the group consisting of NH₄OH, NaOH, KOH and LiOH
15. The process according to any one of the statements 1 to 12, characterized in that the base is an organic bases or an organic supplement.
16. The process according to any one of the statements 1 to 12, characterized in that the base is an organic bases or an organic supplement of the group TPAOH, TPACI, TPABr, DEA, DPA, TBAOH and TEAOH or a combinations thereof.
17. The process according to any one of the statements 1 to 16, characterized in that it comprises stepwise contacting a zeolite suspension with a base, where the number of steps is at least 2, and preferably 4 or higher.
18. The process according to any one of the statements 1 to 16, characterized in that it consists essentially of stepwise contacting a zeolite suspension with a base, where the number of steps is at least 2, and preferably 4 or higher.
19. The process according to any one of the statements 1 to 18, characterized in that the zeolite is contacted with the base by pumping the base through a zeolite-covered membrane, or any other configuration that is not equal to a batch reactor or a plug flow reactor, such as continuous stirred-tank reactor.
20. The process according to any one of the previous statements 1 to 19, characterized in that the sequence of post-synthetic modifications can be executed without the need for filtration in between individual treatments.
21. A process of alkaline leaching of a porous solid according to any one of the previous statements 1 to 20, whereby the method comprises a number of base additions per reaction (x), an amount of base added per addition (m₁ the), a number of solid additions per reaction (y), an amount of solid added per addition (m₂), a number of treatments (z), characterised in that x, y, and z are not equal to 1.
22. A process of alkaline leaching of a porous solid according to any one of the previous statements 1 to 21, whereby when x is equal to 1 that z is 2 addition, x*m1*z is adapted to an overall amount of base contacted with the porous solid, ensure the desired effect of the leaching but avoiding fragmentation.
23. A process of alkaline leaching of a porous solid according to any one of the previous statements 1 to 21, but so designed by controlling y, z or x the alkaline leaching that although the porous solid is subjected to a same overall amount of base or that a same overall amount of base is contacted with the porous solid (which is a prerequisite to ensure the desired effect of the leaching) but is less drastic than subjecting porous solid of 20-40 g L-1 in an aqueous solution contacted with a fixed alkalinity of 0.1 to 0.2 M NaOH, typically for about 20 to 40 min.
24. A process of alkaline leaching of a porous solid according to any one of the previous statements 1 to 23, but so designed that although the porous solid is subjected to a same overall amount of base by controlling y, z or x the alkaline leaching is less drastic than subjecting porous solid of 20-40 g L-1 in an aqueous solution contacted with a fixed alkalinity of 0.1 to 0.2 M NaOH, typically for about 20 to 40 min. at a temperature of 45 to 85° C.
25. A process of alkaline leaching of a porous solid according to any one of the previous statements 1 to 23, but so designed that although the porous solid is subjected to a same overall amount of base by controlling y, z or x so that no fragmentation of components of the porous solid occurs.
26. A process of alkaline leaching of a porous solid according to any one of the previous statements 1 to 23, but so designed that although the porous solid is subjected to a same overall amount of base by controlling y, z or x so that basically no fragmentation of components of the porous solid occurs.
27. A process of alkaline leaching of a porous solid according to any one of the previous statements 1 to 23, but whereby the porous solid is crystalline and the process is so designed that although the porous solid is subjected to a same overall amount of base by controlling y, z or x basically no crystal fragmentation occurs.
28. A process of alkaline leaching of a porous solid according to any one of the previous statements 1 to 23, whereby x is equal to 1 but whereas z is 2 (or higher).
29. A process of alkaline leaching of a porous solid according to any one of the previous statements 1 to 23, alkaline leaching is on porous solid at 5 to 60 g/L, preferably 20 to 40 g/L, and whereby the method comprising subjecting the porous solid to a treatment regime several reaction of mild conditions of NaOH at a temperature between 40 to 70° C., preferably a temperature between 60 to 75° C. and a reaction time of 5 to 150 min., preferably 20 to 40 min whereby the treatment regime comprises w treatments of z amounts of NaOH to have the same amount of NaOH consumed as one treatment of 0.15 to 0.25 M NaOH.
30. A process of alkaline leaching of a porous solid according to any one of the previous statements 1 to 29, whereby the porous solid a porous silicate solid
31. A process of alkaline leaching of a porous solid according to any one of the previous statements 1 to 29, whereby the porous solid is a material with a typology of the group consisting of MWW, BEA, MFI, CHA, MOR, MTW, RUB, LEV, FER, MEL, RTH AEL, AFI, CHA, DON, EMT, CFI, CLO, TON, FER, ERI, MEL, MTW, MWW, HEU, EUO, RHO, LTL, LTA and MAZ.
32. A process of alkaline leaching of a porous solid according to any one of the previous statements 1 to 29, whereby the silicate solid is a material with a typology of the group consisting of MOR, MFI, BEA and FAU.
33. A process of alkaline leaching of a porous solid according to any one of the previous statements 1 to 29, whereby the silicate solid is a porous crystalline silicates
34. A process of alkaline leaching of a porous solid according to any one of the previous statements 1 to 29, whereby the silicate solid is a porous crystalline silicates having zeolitic structure.
35. A process of alkaline leaching of a porous solid according to any one of the previous statements 1 to 29, whereby the silicate solid is a porous amorphous silicate
36. A process of alkaline leaching of a porous solid according to any one of the previous statements 1 to 29, whereby the silicate solid is a porous alumino-silicate (e.g. MCM-41 or SBA-15).
37. The process according to any one of the previous statements 1 to 36, whereby the maximum concentration of hydroxyls in solution does not exceed more than 20% compared to the maximum concentration of hydroxyls applied in the state of the art alkaline leaching of the same solid, and most preferably when said concentration does not exceed 10% of the concentration applied in that state of the art process.
38. Use of the process of any of the previous statements 1 to 36, to more easily recover produced solids from aqueous suspensions compared to solids alkaline-treated in the state of the art.
39. Use of the process of any of the previous statements 1 to 36, to more easily recover produced solids from aqueous suspensions compared to compared to the solids prior to base-treatment.
40. Use of the process of any of the previous statements 1 to 36, to improve solids with decreasing cation exchange capacity, decreasing framework density, and decreasing crystal size.
41. Use of the process of any of the previous statements 1 to 36, to improve solids in alkaline suspensions with increasing solid-to-liquid ratio, and presence of organic species, such as amines or tetraalkylammonium cations.
42. Use of the process of any of the previous statements 1 to 36, to improve solids that are obtained when separation is performed, but not limited to, membrane filtration techniques, such as Buchner set-ups.
43. Use of the process of any of the previous statements 1 to 36, to improve solids in Buchner-type set-ups with decreasing pore size of the filter media and increasing filter cake heights, that is, amount of zeolite per unit surface area of filter media.
44. A solid or solids obtainable by any one of the previous statements 1 to 36, said solid or solids comprising a lower degree of fragmentation and accordingly larger particles sizes, compared to the state if the art.
45. The solid according to statement 44, characterized in that it comprises a mesopore formation
46. The solid according to statement 44, characterized in that it enables to reduce the time of filtration up to, but not limited to, 100-fold compared to a similar state of the art solid.
47. The solid according to statement 44, characterized in that by the mild alkaline treatment it enables to reduce the losses of solids in the form of fines (fragmented particles) during the filtration step.
48. The solid according to statement 44, characterized in that by the mild alkaline treatment it is adapted for mesopore formation, but can also be applied for other applications.
49. The solid according to statement 44, characterized in that by the mild alkaline treatment it is adapted changing of composition of phases, changing elemental composition, or combinations thereof
50. The solid according to statement 44, characterized in that it is microporous crystalline materials comprising superior physico-chemical properties in terms of (the combination of) a larger external surface area (Sₘₑₛₒ), higher micropore volume (V_{micro}), higher relative crystallinity, and higher Brønsted acidity compared to the state of the art.
51. The solid according to statement 44, characterized in that it displays superior performance in catalyzed reactions, obtaining higher activity and selectivity, and longer catalyst life times.
52. Use of the solid according to any one of the statements 44 to 51, in further post-synthetic modifications, such as acid or basic modifications and other steps such as binding, forming, and extrusion.
53. Use of the solid according to any one of the statements 44 to 51, in catalysis for instance catalysis in acid-and or base-catalyzed reactions such as isomerization, carbon-carbon couplings, and cracking.
54. Use of the zeolitic solid or zeolite according to any one of the statements 44 to 51, in catalysis such solid featuring other secondary phases such as alumina, silica, or metals, the zeolites and yield a better dispersion of these secondary phases due to the process.
55. Use of the solid according to any one of the statements 44 to 51, in adsorptive or ion exchange processes.

### EXAMPLES

The following comparative examples 1-15 are used to demonstrate the state of the art and serve as comparison highlighting the value of the invention. The starting zeolites were not dissolved and were not contacted with any base prior to executing the comparative examples.

### Comparative Example 1

3.3 g of USY (FAU topology, Si/Al=30) was contacted with 100 mL of distilled water in which previously NaOH had been dissolved at m_{b,total}/mₛ=0.24 g g⁻¹ (0.2 M of base). This was achieved by adding the zeolite to the vigorously stirred alkaline solution at 65° C. where it was left to react for 30 min. This procedure is referred to as ‘conventional treatment’. After the reaction, the suspension was directly transferred to a Buchner set-up under vacuum with a Whatman filter #5 (9 cm diameter, 2.5 μm pores). The filtration time of this suspension was 119 min. As the inorganic porous solid was added after the base, where it takes several minutes to be completely brought into suspension, this gives a high contacting rate of at least 6 mmol g⁻¹ min⁻¹.

### Comparative Example 2

6.6 g of USY (FAU topology, Si/Al=30) was exposed to a conventional treatment, but with an m_{b,total}/mₛ of 0.48 g g⁻¹ of NaOH (0.4 M NaOH) instead of 0.24 g g⁻¹. After the reaction, the suspension was directly transferred to a Buchner set-up under vacuum with a Whatman filter #5. The filtration time of this suspension was 420 min.

### Comparative Example 3

3.3 g of USY (FAU topology, Si/Al=30) was exposed to a conventional treatment with an m_{b,total}/mₛ of 0.36 g g⁻¹ of NaOH instead of 0.24 g g⁻¹. After the reaction, the suspension was directly transferred to a Buchner set-up under vacuum with a Whatman filter #5. The filtration time of this suspension was 390 min.

### Comparative Example 4

33 g of USY (FAU topology, Si/Al=30) was exposed to a conventional treatment at the 1 L scale, using 0.2 M NaOH. After the reaction, the suspension was directly transferred to a Buchner set-up under vacuum with a Whatman filter #4 (9 cm diameter, pore size 25 μm). The filtration time of this suspension was 384 min. This relates to a filtration time of 12 min per gram of initial USY zeolite.

### Comparative Example 5

33 g of USY (FAU topology, Si/Al=30) was suspended in 1 L of water for 30 min under vigorous stirring. Afterwards, the suspension was directly transferred to a Buchner set-up under vacuum with a Whatman filter #4 (9 cm diameter, pore size 25 μm). The filtration time of this suspension was 170 min. This relates to a filtration time of 5 min per gram of initial USY zeolite.

### Comparative Example 6

3.3 g of USY (FAU topology, Si/Al=466) was exposed to a conventional treatment. After the reaction, the suspension was directly transferred to a Buchner set-up under vacuum with a Whatman filter #5. The filtration time of this suspension was 285 min.

### Comparative Example 7

3.3 g of USY (FAU topology, Si/Al=15) was exposed to a conventional treatment. After the reaction, the suspension was directly transferred to a Buchner set-up under vacuum with a Whatman filter #5. The filtration time of this suspension was 12.5 min.

### Comparative Example 8

3.3 g of USY (FAU topology, Si/Al=30) was exposed to a conventional treatment with, in addition, 0.2 M of TPABr. After the reaction, the suspension was directly transferred to a Buchner set-up under vacuum with a Whatman filter #5. The filtration time of this suspension was 252 min. The crystallinity of this sample was 81% compared to the untreated parent zeolite, and 91% compared to reference NaY CBV100, and 124% compared to NIST standard alumina (SRM 676).

### Comparative Example 9

3.3 g of USY (FAU topology, Si/Al=30) was exposed to a conventional treatment with, in addition, 0.01 M of TPABr. After the reaction, the suspension was directly transferred to a Buchner set-up under vacuum with a Whatman filter #5. The filtration time of this suspension was 195 min. The cavitation ratio of the resulting sample was 1.85.

### Comparative Example 10

3.3 g of beta (BEA topology, Si/Al=255) was exposed to a conventional treatment. After the reaction, the suspension was directly transferred to a Buchner set-up under vacuum with a Whatman filter #5. The filtration time of this suspension was 62.7 min.

### Comparative Example 11

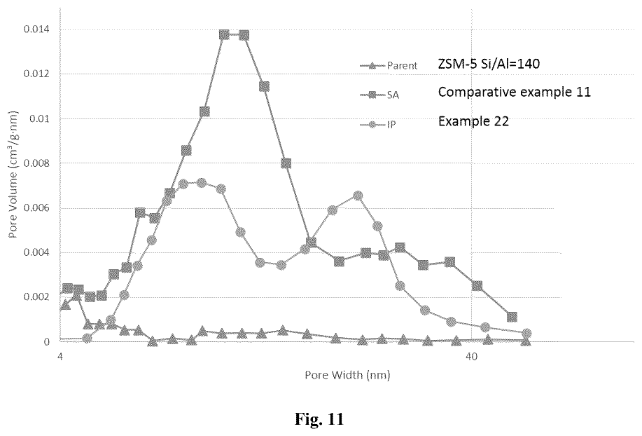

3.3 g of ZSM-5 (MFI topology, Si/Al=140) was exposed to a conventional treatment. After the reaction, the suspension was directly transferred to a Buchner set-up under vacuum with a Whatman filter #5. The filtration time of this suspension was 66.6 min. This sample displayed a crystallinity of 87% compared to the parent zeolite, and 319% compared to NIST standard alumina (SRM 676). Moreover, the sample displayed a microporosity of 0.06ml g⁻¹, an mesopore surface of 288 m² g⁻¹, and a uni-modal mesoporosity centred around 10 nm as illustrated in FIG. 11.

### Comparative Example 12

3.3 g of silicalite (MFI topology, Si/Al=940) was exposed to a conventional treatment. After the reaction, the suspension was directly transferred to a Buchner set-up under vacuum with a Whatman filter #5. The filtration time of this suspension was 11 min. The crystallinity of this sample was 76% compared to the untreated parent zeolite.

### Comparative Example 13

3.3 g of SAPO-11 (AEL topology, Al/Si=10, P/Si=9, Al/P=1.1) was exposed to a conventional treatment using 0.4 M DEA instead of 0.2 M NaOH and 60 min instead of 30 min. After the reaction, the suspension was directly transferred to a Buchner set-up under vacuum with a Whatman filter #5. The filtration time of this suspension was >400 min.

### Comparative Example 14

10 g of clinoptilolite (HEU topology) was acid treated 4 times following the conditions as mentioned in the state of the art (Chem. Mater., 2013, 25, 1947-1959). Of this de-aluminated clinoptilolite (Si/Al=10), 3.3 g was exposed to a conventional treatment using 0.1 M NaOH instead of 0.2 M NaOH. After the reaction, the suspension was directly transferred to a Buchner set-up under vacuum with a Whatman filter #5. The filtration time of this suspension was 8.1 min.

### Comparative Example 15

3.3 g of USY (FAU topology, Si/Al=30) is contacted according to the conventional treatment with aqueous NaOH, with the exception that m_{b,total}/mₛ=0.12 g g⁻¹ was used instead of m_{b,total}/mₛ=0.24 g g⁻¹. After the reaction, the suspension was directly transferred to a Buchner set-up under vacuum with a Whatman filter #5. The filtration time of this suspension was 2.5 min. Hereafter, the resulting solid was dried (6 h) at 100° C. and afterwards again contacted according to the conventional treatment, with the exception that m_{b,total}/mₛ=0.12 g g⁻¹ was used instead of m_{b,total}/mₛ=0.24 g g⁻¹. After this second reaction, the suspension was directly transferred to a Buchner set-up under vacuum with a Whatman filter #5. The filtration time of this suspension was 2.6 min, a total filtration time of 5.1 min. The resulting solid was completely amorphous, had a process time 425 min, and yielded an undesired double amount of waste water.

The following examples are according to preferred embodiments of the invention. The starting zeolites were not dissolved and were not contacted with any base prior to executing the inventive examples.

### Example 16

3.3 g of USY (FAU topology, Si/Al=30) is contacted according to the conventional treatment, with the exception that the NaOH concentration was 0.05 M instead of 0.2 M NaOH. During the treatment powdered NaOH (0.05 moles per litre of solution) was added 3 times every 7.5 min to achieve a m_{b,total}/mₛ=0.24 g g⁻¹. After the reaction, the suspension was directly transferred to a Buchner set-up under vacuum with a Whatman filter #5. The filtration time of this suspension was 1.9 min. Moreover, the process time, number of steps, and amount of waste water were not negatively influenced, as is the case in Example 15.

### Example 17

3.3 g of USY (FAU topology, Si/Al=30) is contacted with the same amount of base during the same time and at the same temperature as the conventional treatment. The base was added gradually, to the zeolite suspended in 90 mL of vigorously stirred water, using a syringe pump equipped with a 2 M NaOH solution at a rate of 20 ml h⁻¹. After the reaction, the suspension was directly transferred to a Buchner set-up under vacuum with a Whatman filter #5. The filtration time of this suspension was 2.3 min. The NaOH was added at mb, total/ms =0.24 g g⁻¹. The addition rate was accordingly 0.2 mmol g⁻¹ min⁻¹.

### Example 18

3.3 g of beta (BEA topology, Si/Al=255) is contacted with the same amount of base during the same time and at the same temperature as the conventional treatment. The base was added gradually, to the zeolite suspended in 90 mL of vigorously stirred water, using a syringe pump equipped with a 2 M NaOH solution at 20 ml h⁻¹. After the reaction, the suspension was directly transferred to a Buchner set-up under vacuum with a Whatman filter #5. The filtration time of this suspension was 10.1 min.

Example 19

3.3 g of USY (FAU topology, Si/Al=30) was exposed the treatment in Example 17, with 3 M NaOH in the syringe pump instead of 2 M NaOH. After the reaction, the suspension was directly transferred to a Buchner set-up under vacuum with a Whatman filter #5. The filtration time of this suspension was 149 min. That is less than 50% of the time compared to the state of the art, as displayed in comparative example 3.

### Example 20

33 g of USY (FAU topology, Si/Al=30) was exposed to a treatment as in Example 17 (m_{b,total}/mₛ=0.24 g g⁻¹), however at a tenfold volume, with 5 M NaOH in the syringe pump instead of 2 M NaOH and an addition rate of 80 ml h⁻¹. After the reaction, the suspension was directly transferred to a Buchner set-up under vacuum with a Whatman filter #4. The filtration time of this suspension was 115 min. This relates to a filtration time of 3 min per gram of initial USY zeolite, indicating that the filtration is faster compared to the experiment performed on the same scale using state of art technology (Example 4). Moreover, the filtration time indicates that the separation is even easier compared to putting the same amount of zeolite in the same amount of a non-alkaline solution consisting only of distilled water (Example 5). This accordingly indicates that the inventive base leaching technique may even be used to enhance the separation of the zeolites from solutions and therefore goes clearly beyond the state of the art.

### Example 21

33 g of USY (FAU topology, Si/Al=30) was exposed to a treatment as in Example 17, however at a tenfold volume, with 2.5 M NaOH solution in the syringe pump operated at 40 ml h⁻¹. After the reaction, the suspension was directly transferred to a Buchner set-up under vacuum with a Whatman filter #4. The filtration time of this suspension was 120 min. This relates to a filtration time of 3.6 min per gram of initial USY zeolite, indicating that the filtration is faster compared to the experiment performed on the same scale using state of art technology (Example 4). Moreover, the filtration time indicates that the separation is even easier compared to putting the same amount of zeolite in the same amount of a non-alkaline solution consisting only of distilled water (Example 5). This accordingly indicates that the inventive base leaching technique may even be used to enhance the separation of the zeolites from solutions and therefore goes clearly beyond the state of the art.

### Example 22

3.3 g of ZSM-5 (MFI topology, Si/Al=140) is contacted with the same amount of base during the same time and at the same temperature as the conventional treatment. The base was added gradually, to the zeolite suspended in 90 mL of vigorously stirred water, using a syringe pump equipped with a 2 M NaOH solution at 20 ml h⁻¹. After the reaction, the suspension was directly transferred to a Buchner set-up under vacuum with a Whatman filter #5. The filtration time of this suspension was 39.4 min. This sample displayed a crystallinity of 96% compared to the parent zeolite, and 353% compared to NIST standard alumina (SRM 676). Moreover, the sample displayed a microporosity of 0.07 ml g⁻¹, a mesopore surface of 262 m2 g-1, and bimodal mesoporosity (mesopore sizes 8 nm and 20 nm) was obtained as illustrated in FIG. 11, which is significantly different compared to the unimodal mesoporosity displayed by the sample synthesized in comparative Example 11.

### Example 23

3.3 g of SAPO-11 (AEL topology, Al/Si=10, P/Si=9, Al/P=1.1) is contacted with the same amount of base during the same time and at the same temperature as in Example 13. The base was added gradually, to the zeolite suspended in 90 mL of vigorously stirred water, using a syringe pump equipped with a 4 M DEA solution at 20 ml h⁻¹. After the reaction, the suspension was directly transferred to a Buchner set-up under vacuum with a Whatman filter #5. The filtration time of this suspension was 82 min.

Example 24

3.3 g of USY (FAU topology, Si/Al=30) was exposed to the treatment as in Example 17, wherein the aqueous solution is complemented with 0.01 M TPABr. After the reaction, the suspension was directly transferred to a Buchner set-up under vacuum with a Whatman filter #5. The filtration time of this suspension was 2.0 min. The cavitation ratio of the resulting sample was 1.51.

### Example 25

10 g of clinoptilolite (HEU topology) was acid treated 4 times following the conditions of the state of the art, as described in Chem. Mater., 2013, 25, 1947-1959. Of this de-aluminated clinoptilolite (Si/Al=10), 3.3 g was exposed according to the treatment in Example 17, with 1 M NaOH in the syringe pump instead of 2 M NaOH. After the reaction, the suspension was directly transferred to a Buchner set-up under vacuum with a Whatman filter #5. The filtration time of this suspension was 6.2 min.

### Example 26

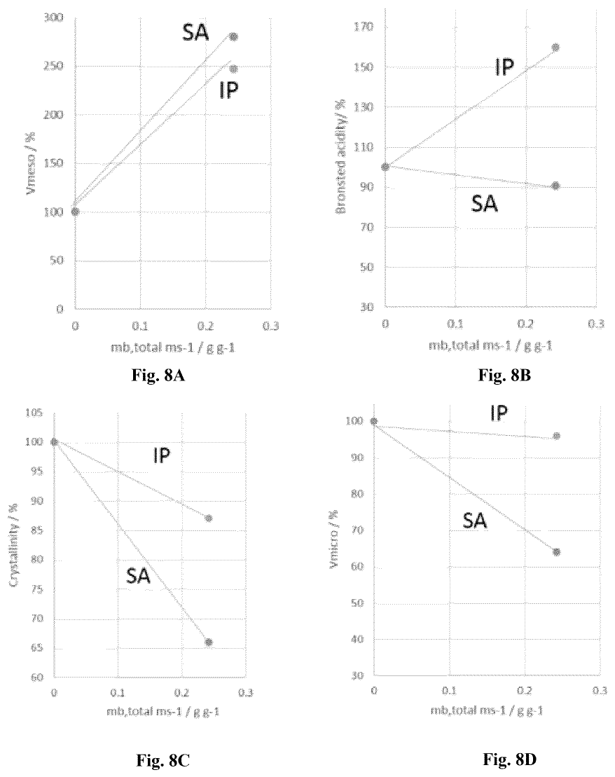

The porous properties of selected samples, as assessed using routine nitrogen adsorption at 77 K, are summarized in Table 1. Herein, it becomes evident, that the samples prepared using the invention feature larger external surface areas, and better preserved, hence larger, micropore volumes. Also it is evident from Table 1 that the invention yields the lowest filtration and process times. Further details of these materials are included in FIGS. 8, 9, 10, 11 and in Tables B, C, and D. It may be highlighted that the preservation of intrinsic properties can be dependent on the type of zeolite and the nature and amount of the used base and organics. Accordingly, comparison between the state of the art and the invention should be performed primarily between samples prepared in a similar fashion, except for the manner in which the base was added. This can be for example done using comparative Example 9 and Example 24 on zeolite USY-III, where in both cases the zeolite is treated at m_{b,total}/mₛ=0.24 g g⁻¹, using 0.01 M TPABr. Here, it can be observed that the conventional technique yields a microporosity of 0.09 cm3 g⁻¹ using 0.17 g TPABr per gram final zeolite (Table 1). Executing the same treatment using the inventive technology yields a value of 0.15 cm³ g⁻¹ using 0.17 g TPABr per gram final zeolite (Table 1). Hence, using the state of the art technique a microporosity of 0.53 cm3 per gram of TPABr is obtained (Example 9). However, for the inventive technique this value equals 0.88 cm³ microporosity per gram of TPABr (Example 24), suggesting that the organics are used at least 50% more effectively.

### Comparative Example 27

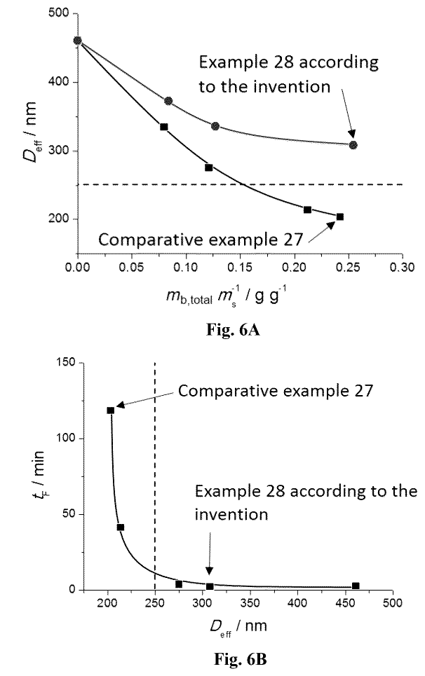

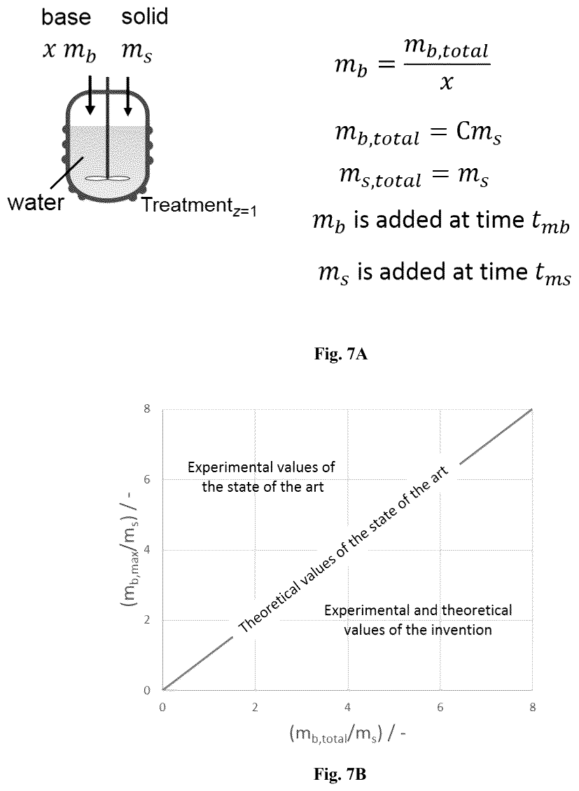

The suspension obtained by the conventional treatment in Example 1, as well as other samples prepared in the conventional manner were subjected to study using dynamic light scattering (DLS). Accordingly, the supernatant of the centrifuged (15 min at 12,000 rpm) alkaline treated zeolites was measured in polystyrene cuvettes on a 90Plus Particle Size Analyzer (Brookhaven) equipped with 659 nm laser, under a detection angle of 90°. Fluctuations in the scattered light intensity were correlated between 10 ms and 5 s. Correlation functions were analyzed with Igor Pro 6.2, using the Clementine package for modelling of decay kinetics based on the Maximum Entropy method. The decay time was converted to a hydrodynamic diameters using the Stokes-Einstein equation. FIG. 6a shows the resulting effective diameter (D_{eff}). Upon contacting the USY-III zeolite with an increasing amount of NaOH, the D_{eff} goes down from 450 nm down to 200 nm. Particularly below the 250 nm, extremely long filtration times start to occur (FIG. 6b).

### Example 28

The solution resulting from the treatment in Example 17 was exposed to the same characterization as in Example 27. FIG. 6a shows that using the invention enables to contact the same amount of inorganic porous solid with base, but maintain a much larger D_{eff} (>300 nm). This indicates that defragmentation must be substantially reduced in the solids produced in Example 27.

### Example 29

1 g of USY (Si/Al=30) was inserted in a membrane filtration cell, equipped with a Whatman filter #5. Then 200 ml of a 0.4 M diethylamine (DEA) solution was added, after the mixture reached a temperature of 65°° C. a pressure was added as to effectuate the filtration of the DEA solution through the zeolite bed in 1 hour. This step was repeated once, yielding an overall yield of 52%. By flowing a base on a zeolite membrane, the zeolite is contacted with the base in a gradual way. In this case x would be infinitely large. This was performed according to the experimental configuration displayed in FIG. 2.

### Example 30

The acidity of the solids obtained in comparative Example 9 and Example 24 were characterized using Fourier-transform infrared spectroscopy after adsorption of pyridine. These measurements were performed by using a Nicolet 6700 spectrometer equipped with a DTGS detector. Samples were pressed into self-supporting wafers and degassed at 400° C. for 1 h in vacuo before measurements. Brønsted and Lewis acid sites were analysed by using a pyridine probe. After evacuation, the samples were subjected to 4-5 pulses of at least 25 mbar of pyridine at 50° C. for 1 min (until saturation). The absorptions at 1550 and 1450 cm⁻¹ corresponded to the amount of Brønsted and Lewis acid sites, respectively. The extinction coefficients were determined by Emeis in J. Catal, 1993, 141, 347-354. The results (Table 1) demonstrate that, although in the preparation of both samples the same amount of TPABr was used, the solid obtained in Example 24 comprises more than double the amount of Brønsted sites. This proves that the solids obtained using the invention clearly possess superior acidity compared to those in the prior art.

### Example 31

The crystallinity of the solids obtained in Example 9 and Example 24 was assessed. The results (Table 1) demonstrate that, although in the preparation of both samples the same amount of TPABr was used, the solid obtained in Example 24 comprises a doubled crystallinity. This proves that the solids obtained using the invention clearly possess superior crystallinity compared to those in the prior art, and that the TPABr was more efficiently used.

### Example 32

The solids obtained after Example 1, Example 8, Example 9, Example 17, and Example 24 were converted to the protonic form using a standard 0.1 M NO₃NH₄ ion exchange (room temperature, 12 h, 3 repetitions), followed by calcination (550° C., 5 h, ramp rate 5° C. min⁻¹). Afterwards, the solids were catalytically evaluated in the conversion of □-pinene, a suitable model reaction to test activity and selectivity. The isomerization reactions were carried out in a 50 cm³ Parr reactor with a sampling device at 150° C. under 6-8 bar of nitrogen with a stirring speed of 750 rpm. A mixture of substrate (20 g; □-pinene) and catalyst (0.1 g) was heated to 100°° C., after which time the first liquid sample was taken. The reaction mixture was then further heated to 150° C. and more samples were taken 10, 30, and 60 min after the first sample. The samples were then analysed on a gas chromatograph (HP 5890, Hewlett Packard) equipped with an HP1 column and a flame ionization detector (FID). Tetradecane was used as an external standard. Unidentified products were analysed by GC-MS (6890N, Agilent Technologies). The activity of the samples was determined by using the slope of the linear part of the conversion of □-pinene versus the contact time plot. The results are summarized in Table 1, and show that, compared to the state of the art, the materials obtained using the invention display superior activity and selectivity.

TABLE 1
Physico-chemical properties and catalytic performance of various USY zeolites.

| | | | | | Waste | | | | | | |
|---|---|---|---|---|---|---|---|---|---|---|---|
| | Sₘₑₛₒ^{a} | V_{micro}^{a} | Cryst.^{b} | t_{F}^{c} | water^{d} | t_{P}^{e} | B^{f} | L^{f} | A^{g} | P^{g} | P/A^{h} |
| Example | [m² g⁻¹] | [cm³ g⁻¹] | [%] | [min] | [ml g⁻¹] | [min] | [μmol g⁻¹] | [μmol g⁻¹] | [h⁻¹] | [h⁻¹] | [—] |
| non-treated | 231 | 0.27 | 100 | na | na | na | 158 | 26 | 48 | 47 | 0.98 |
| Example 1 | 363 | 0.00 | 0 | 119 | 30 | 149 | 39 | 65 | 204 | 165 | 0.81 |
| Example 8 | 436 | 0.20 | na | 252 | 30 | 282 | 172 | 81 | 279 | 250 | 0.90 |
| Example 9 | 211 | 0.09 | 30 | 195 | 30 | 225 | 63 | 40 | 201 | 180 | 0.90 |
| Example 15 | 430 | 0.00 | 0 | 5 | 60 | 425 | na | na | na | na | na |
| Example 16 | 607 | 0.00 | na | 2 | 30 | 32 | na | na | na | na | na |
| Example 17 | 405 | 0.00 | na | 2 | 30 | 32 | na | na | 215 | 190 | 0.88 |
| Example 24 | 401 | 0.15 | 56 | 2 | 30 | 32 | 147 | 73 | 276 | 259 | 0.94 |

^{a}Mesoporosity (Sₘₑₛₒ) and microporosity (V_{micro}) as measured by nitrogen adsorption.
^{b}Crystallinity as measured by XRD,
^{c}Filtration time (t_{F}) following the alkaline treatment.
^{d}Produced waste water during the alkaline treatment per gram of initial zeolite.
^{e}Process time (t_{P}) relates to the cumulative time it takes to execute the alkaline treatment and the subsequent filtration. In the case of a multistep treatment, the total treatment and filtration time is complemented with the required drying step in between the filtration and subsequent alkaline treatment.
^{f}Brønsted (B) and Lewis (L) acidity as measured with pyridine adsorption.
^{g}Activity (A) and productivity (P) of the catalyst (after a standard ion exchange and calcination) in the conversion of α-pinene. The unit of A is gram of α-pinene converted per gram of catalyst per hour. The unit of P is gram of useful products (limonene, camphene, α-terpinene, γ-terpinene, terpinoline, p-cymene) formed per gram of catalysts per hour.
^{h}P/A is a measure for the selectivity to desired products of the zeolite catalysts.

### Comparative Example 33

### Conventional Base Leaching Techniques

Table A illustrates the physico-chemical properties of conventional and base-treated zeolites using the state of the art technology. Data is shown relative to the starting zeolites.

Table A illustrates the physico-chemical properties of conventional
and base-treated zeolites using the state of the art technology.
Data is shown relative to the starting zeolites.

| | | | | | Filtra- |
|---|---|---|---|---|---|
| | Mesopor- | Micro- | Crystal- | Brønsted | tion |
| | osity^{a} | porosity^{a} | linity^{a} | acidity^{a} | time^{b} |
| Zeolite | (%) | (%) | (%) | (%) | (%) |
| USY-I (CBV | 100 | 100 | 100 | 100 | 100 |
| 712, Si/Al = 6)- | | | | | |
| conventional | | | | | |
| USY-I-base | 386 | 97 | 54 | 67 | 200 |
| leached | | | | | |
| USY-II (CBV | 100 | 100 | 100 | 100 | 100 |
| 720, Si/Al = 15)- | | | | | |
| conventional | | | | | |
| USY-II-base | 297 | 81 | 64 | 57 | 3400 |
| leached | | | | | |
| USY-III (CBV | 100 | 100 | 100 | 100 | 100 |
| 760, Si/Al = 30)- | | | | | |
| conventional | | | | | |
| USY-III-base | 296 | 78 | 76 | 93 | 4400 |
| leached | | | | | |
| ZSM5 (CBV | 100 | 100 | 100 | 100 | 100 |
| 8014, Si/Al = 40)- | | | | | |
| conventional | | | | | |
| ZSM-5-base | 700 | 57 | 72 | 84 | 600 |
| leached | | | | | |
| beta-(HSZ- | 100 | 100 | 100 | 100 | 100 |
| 940HOA, | | | | | |
| Si/Al = 20)- | | | | | |
| conventional | | | | | |
| Beta-base | 313 | 90 | 61 | 76 | 500 |
| leached | | | | | |

^{a}Porosity, crystallinity, and acidity data were obtained from ACS Catalysis 2015, 5, 734.
^{b}Filtration times were obtained by reproduction of the experiments from ACS Catalysis 2015, 5, 734 on a 100 ml scale, and filtration using a Buchner set-up with Whatman filter #5 paper (9 cm in diameter). The filtration time of the non-treated conventional zeolites was obtained by filtration of a suspension of 3.3 g of zeolite in 100 ml distilled water using a Buchner set-up with Whatman filter #5 paper (9 cm in diameter).

### Example 34

### Comparison with Conventional Base Leaching Techniques

FIG. 8 illustrates the effects of the alkaline treatments on the mesopore volume (Vₘₑₛₒ), Brønsted acidity, crystallinity, and micropore volume (V_{micro}), relative to the untreated (parent) zeolite. The treatments of the state of the art (referred to as “SA”) and the invention (referred to as “IP”) were performed with similar total base (NaOH) amounts compared to the amount of treated zeolite (at m_{b,total}/mₛ=0.24 g g⁻¹). Treatments were performed as in the state of the art (SA), as described in ACS Catalysis 2015, 5, 734:3.3 g of USY-I was contacted with 100 mL in which was dissolved 0.8 g NaOH at 65° C. for 30 min in a stirred round-bottomed flask. After the reaction, the solid was isolated from the suspension using Buchner filtration. For the invention (IP): 3.3 g of USY-I was suspended in 90 mL of water to which the base was added gradually during 30 min at a rate of 0.2 mmol of NaOH per gram of starting zeolite per min. After the reaction, the solid was isolated from the suspension using Buchner filtration. After the alkaline treatments, the samples were, following protocols described in ACS Catalysis 2015, 5, 734, exposed to a standard acid washing in 50 ml water complemented with Na₂H₂EDTA (0.55 g per gram of zeolite) at 95° C. for 6 h, followed by 3 ion exchanges in 250 mL water complemented with NH₄NO₃ (0.8 g per gram of zeolite), followed by filtration, and calcination at 550° C. for 5 h.

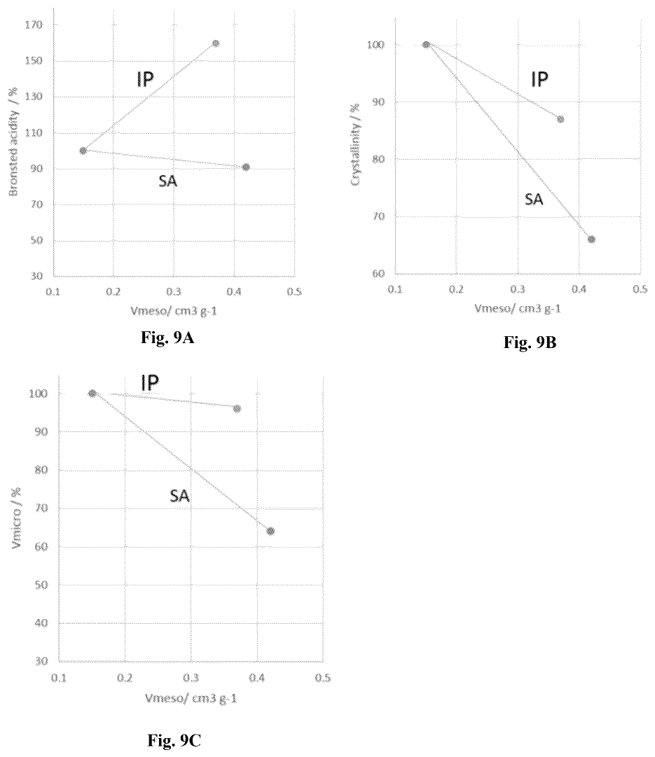

FIG. 9 illustrates the impact on the intrinsic zeolitic properties as a function of the desired introduction of secondary porosity (Vₘₑₛₒ) using state of the art (SA) or inventive technology (IP). The samples were prepared as described in Example 34. All data is relative to the untreated (parent) zeolite.

Table B illustrates the crystallinity, porosity and acidity of conventional and base treated USY-I zeolites.

TABLE B
illustrates the crystallinity, porosity and acidity of conventional and base treated USY-I zeolites.

| | m_{b, total}/mₛ^{a} | Vₘₑₛₒ^{b} | V_{micro}^{b} | Crystallinity^{c} % | | | Acidity^{d} | Acidity^{e} | P^{f} | P/Vₘₑₛₒ^{g} |
|---|---|---|---|---|---|---|---|---|---|---|
| Sample | (g g⁻¹) | ml g⁻¹ | ml g⁻¹ | parent | NIST | NaY | μmol g⁻¹ | ^{%} | h⁻¹ | a.u. |
| USY-I- | — | 0.15 | 0.25 | 100 | 130 | 98% | 346 | 100 | 31 | 207 |
| conventional | | | | | | | | | | |
| USY-I-base | 0.24 | 0.42 | 0.16 | 66 | 71 | 65 | 314 | 88 | 202 | 481 |
| treated | | (+180%)^{h} | (−36%) | (−34%) | | | (−9%) | (−12%) | (+552%) | (+132%) |
| comparative | | | | | | | | | | |
| USY-I-base | 0.24 | 0.37 | 0.24 | 87 | 109 | 86 | 553 | 146 | 254 | 686 |
| treated | | (+147%) | (−4%) | (−13%) | | | (+60%) | (+46) | (+719%) | (+231%) |
| inventive | | | | | | | | | | |

^{a}Base treatments were performed accordingly to Example 34. All base-treated samples were washed afterwards using a standard acid treatment as defined in Example 34.
^{b}Nitrogen adsorption.
^{c}XRD, compared the parent USY-I zeolite (‘parent’), to a NIST standard alumina (SRM 676) (‘NIST’), or a standard NaY (CBV 100 provided by Zeolyst) (‘NaY’).
^{d}FTIR of pyridine adsorbed.
^{e}NH₃-TPD.
^{f}Productivity of the catalyst (after a standard ion exchange and calcination) in the conversion of a-pinene, in gram of useful products (limonene, camphene, α-terpinene, γ-terpinene, terpinoline, p-cymene) formed per gram of catalysts per hour.
^{g}The value P/Vₘₑₛₒ relates the productivity to the secondary porosity. It is accordingly a measure for the efficiency of the secondary porosity.
^{h}values in brackets indicate the change induced compared to the starting conventional USY-I zeolite.

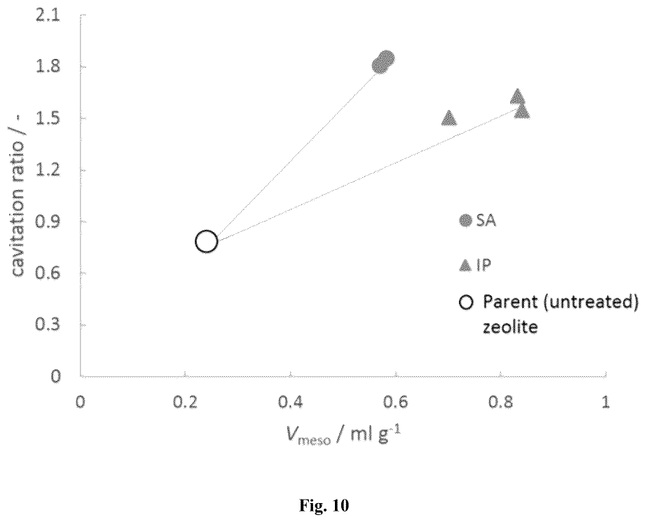

FIG. 10 illustrates the cavitation of mesoporosity after introduction of secondary porosity (Vₘₑₛₒ) using state of the art (solid circles) or inventive (triangles) base leaching techniques. The samples obtained using the methods according to the invention display substantially lower cavitation ratios. These were performed by base leaching on USY III at m_{b,total}/mₛ=0.24 g g⁻¹, complemented with 0.2 M TPABr or 0.01 M TPABr. Similar protocols for the SA and IP were used as mentioned in Example 34, with the exception that the acid wash was not performed.

### Example 35

3.3 g of silicalite (MFI topology, Si/Al=940) is contacted with the same amount of base during the same time and at the same temperature as the conventional treatment. The base was added gradually, to the zeolite suspended in 90 mL of vigorously stirred water, using a syringe pump equipped with a 2 M NaOH solution at 20 ml h⁻¹. After the reaction, the suspension was directly transferred to a Buchner set-up under vacuum with a Whatman filter #5. The filtration time of this suspension was 9 min. The crystallinity of this sample was 107% compared to the untreated parent zeolite.

### Example 36

3.3 g of USY (FAU topology, Si/Al=15) is contacted with the same amount of base during the same time and at the same temperature as the conventional treatment. The base was added gradually, to the zeolite suspended in 90 mL of vigorously stirred water, using a syringe pump equipped with a 2 M NaOH solution at 20 ml h⁻¹. After the reaction, the suspension was directly transferred to a Buchner set-up under vacuum with a Whatman filter #5. The filtration time of this suspension was 2 min.

### Example 37

3.3 g of USY (FAU topology, Si/Al=30) was exposed to the treatment as in Example 17, wherein the aqueous solution is complemented with 0.2 M TPABr. The microporosity of this sample was 0.24 ml g⁻¹. The crystallinity of this sample was 89% compared to the untreated parent zeolite, and 100% compared to reference NaY CBV100, and 143% compared to NIST standard alumina (SRM 676).

### Comparative Example 38

3.3 g of beta (BEA topology, Si/Al=12.5) is contacted with half the amount of base (m_{b,total}/mₛ=0.12 g g⁻¹) during the same time and at the same temperature as the conventional treatment, with in addition, 0.2 M of TPABr. After the reaction, in addition, a standard acid wash, ion exchange and calcination as described in Example 34 was executed. The crystallinity of this sample was 86% compared to the untreated parent zeolite and 477% compared to NIST standard alumina (SRM 676). The sample had a microporosity of 0.15 ml g⁻¹ and a mesopore volume of 0.89 ml g⁻¹.

### Example 39

3.3 g of beta (BEA topology, Si/Al=12.5) was exposed to the treatment as in Example 17, wherein the base amount was half (m_{b,total}/mₛ=0.12 g g⁻¹) and the aqueous solution is complemented with 0.2 M TPABr. After the reaction, in addition, a standard acid wash, ion exchange and calcination as described in Example 34 was executed. The crystallinity of this sample was 95% compared to the untreated parent zeolite and 531% compared to NIST standard alumina (SRM 676). The sample had a microporosity of 0.16 ml g⁻¹ and a mesopore volume of 0.90 ml g⁻¹.

### Comparative Example 40

The USY-I zeolite was base treated in NaOH (at m_{b,total}/mₛ=0.24 g g⁻¹) according to the state of the art as described as in Example 34, with the exception that the acid treatment in Na2H2EDTA was not performed. The obtained sample displayed a Brønsted acidity as measured with pyridine of 247 μmol g⁻¹. Accordingly, based on the information presented in Table B, the acid wash executed after the state of the art alkaline treatment in Example 34 induced an increase in Brønsted acidity of 67 μmol g⁻¹.

### Example 41

The USY-I zeolite was base treated in NaOH (at m_{b,total}/mₛ=0.24 g g⁻¹) according to the invention as described as in Example 34, with the exception that the acid treatment in Na₂H₂EDTA was not performed. The obtained sample displayed a Brønsted acidity as measured with pyridine of 393 μmol g⁻¹. Accordingly, based on the information presented in Table B, the acid wash executed after the inventive base treatment in Example 34 induced an increase in Brønsted acidity of 160 μmol g⁻¹. This proves that the acid wash becomes (over two times) more efficient once the alkaline treatment is performed according the invention.

### New Materials

Following novel materials were prepared using the methods according to embodiments of the invention. The properties of these materials are given in FIGS. 8-11 and Tables A-D.

For USY-I: Crystallinity (FIG. 8, 9, Table B), microporosity (FIG. 8, 9, Table B), acidity (FIG. 8, 9, Table B), Al and Si coordination (MAS NMR, Table C and Table D). For USY-III: Microporosity (Example 37), crystallinity (Example 37), cavitation (FIG. 9), and particle/crystal size (FIG. 6). For ZSM-5: Crystallinity (Example 22) and mesoporosity (Example 22, FIG. 11). For beta: Crystallinity (Example 39).

TABLE C
Aluminium coordination in parent and base-treated
USY-I as evidenced using ²⁷Al MAS NMR spectroscopy.

| | | Extra | Extra |
|---|---|---|---|
| | framework | framework | framework |
| | tetrahedral | pentahedral | Octahedral |
| Sample | species^{a} (%) | species^{a} (%) | species^{a} (%) |
| USY-I-conventional | 46 | 20 | 34 |
| USY-I-conventional-base | 44 | 24 | 31 |
| treated (comparative)^{b} | | | |
| USY-I-conventional-base | 61 | 16 | 23 |
| treated (inventive)^{b} | | | |

^{a}Tetrahedral species (80 to 40 ppm), pentahedral (40 to 10 ppm), and octahedral (10 to −40 ppm).
^{b}The base treatment (m_{b, total}/mₛ = 0.24 g g⁻¹) was complemented with a standard acid wash as described in Example 34.

TABLE D
Silicon coordination in parent and base-treated USY-I
as evidenced using ²⁹Si MAS NMR spectroscopy.

| | Si(2Al) + | | |
|---|---|---|---|
| | Si(3Al)^{a} | Si(1Al)^{a} | Si(0Al)^{a} |
| Sample | (%) | (%) | (%) |
| USY-I-conventional | 7 | 14 | 79 |
| USY-I-conventional-base | 18 | 32 | 50 |
| treated (comparative)^{b} | | | |
| USY-I-conventional-base | 11 | 28 | 61 |
| treated (inventive)^{b} | | | |

^{a}Si(0Al) at −108 ppm, Si(1Al) at −102 ppm, Si(2Al) at −96 ppm, Si(3Al) at −92 ppm.
^{b}The base treatment (m_{b, total}/mₛ = 0.24 g g⁻¹) was complemented with a standard acid wash as described in Example 34.

Difference of the faujasites (USY): Among the available USY zeolites, the most critical difference is the framework Si/Al ratio. The latter is quite different compared to the bulk Si/Al ratio as measured by elemental analysis (due to the presence of extra-framework Si and Al species entrapped in the samples). The Si/Al ratio of the framework strongly dictates its acidity, its stability, and the type and nature of the applied post-synthetic protocol. As the Si/Al of the framework is hard to measure by elemental analysis, it is derived from the XRD pattern (using standardized methods specified by ASTM 3942). As the amount of Al in the framework make the zeolite framework expand, the amount of Al in the framework can be derived from evaluation of the unit cell size. The unit cell sizes of the parent materials are freely available from the zeolite supplier (Zeolyst). For USY-I (CBV 712) it is 24.35 Å, whereas for USY-III (CBV 760) it is 24.24 Å.

The new material USY-I can be uniquely described as:
(based on the unprecedented acidity, see FIGS. 8 and 9, Table B) a zeolite with the faujasite topology with a unit cell size ranging from Å 24.375 to 24.300 Å, with a mesopore volume of at least 0.35 ml g⁻¹, and with a Brønsted acidity of at least 400 μmol g⁻¹ (as measured with pyridine);
(based on the enhanced Al coordination, see Table C) a zeolite with the faujasite topology with a unit cell size ranging from Å 24.375 to 24.300 Å, with a mesopore volume of at least 0.35 ml g⁻¹, with an fraction of Al in the framework, hence tetrahedral coordination, of at least 0.5 (as measured with ²⁷Al MAS NMR);
(based on the preservation of crystallinity during mesopore formation, FIGS. 8, 9, Table B) a zeolite with the faujasite topology with a unit cell size ranging from Å 24.375 to 24.300 Å, with a mesopore volume of at least 0.35 ml g⁻¹, and a crystallinity of at least 75% relative to a standard NaY zeolite, and at least 90% compared to NIST standard alumina (SRM 676).
(based on the preservation of microporosity during mesopore formation, FIGS. 8, 9, Table B) a zeolite with the faujasite topology with a unit cell size ranging from Å 24.375 to 24.300 Å with a mesopore volume of at least 0.35 ml g⁻¹ and a microporosity of at least 0.21 ml g⁻¹ (as measured with nitrogen adsorption); and/or,
(based on the preservation of Si coordination during mesopore formation, Table D) a zeolite with the faujasite topology with a unit cell size ranging from Å 24.375 to 24.300 Å with a mesopore volume of at least 0.35 ml/g and a fraction of Si (OAl) species, hence silicon in the framework tetrahedrally coordinated with 4 Si atoms, exceeding 0.5 (as measured with ²⁹Si MAS NMR).

The new material USY-III can be uniquely described as:
(based on the unprecedented microporosity of mesoporous USY-III, Example 37) a zeolite with the faujasite topology with a unit cell size below 24.300 Å with a mesopore volume of at least 0.35 ml g⁻¹ and a micropore volume of at least 0.22 ml g⁻¹ (as measured with nitrogen adsorption);
(based on the unprecedented crystallinity of mesoporous USY-III, Example 37) a zeolite with the faujasite topology with a unit cell size below 24.300 Å with a mesopore volume of at least 0.35 ml/g and a crystallinity of at least 95% compared to a commercial NaY zeolite, and at least 130% compared to NIST standard alumina (SRM 676);
(based on the reduced cavitation of mesoporous USY-III, FIG. 10) a zeolite with the faujasite topology with a unit cell size below 24.300 Å with a mesopore volume of at least 0.35 ml/g and a mesopore cavitation ratio of at most 1.6 (as measured with nitrogen adsorption); and/or,
(based on the preserved crystal size of mesoporous USY-III, FIG. 6) a zeolite with the faujasite topology with a unit cell size below 24.300 Å with a mesopore volume of at least 0.35 ml g⁻¹ and a particle size D_{eff} of at least 350 nm.

The new material MFI can be uniquely described as:
a zeolite with the MFI topology with a molar Si/Al ratio of at most 400, with a mesopore volume of at least 0.30 ml g⁻¹ and a crystallinity of at least 330% compared to NIST standard alumina (SRM 676).

The new material BEA can be uniquely described as:
a zeolite with the BEA topology with a mesopore volume of at least 0.50 ml g⁻¹ and a crystallinity of at least 500% compared to NIST standard alumina (SRM 676).

1-15. (canceled)

16. A method for treating zeolite, comprising contacting a zeolite with a basic solution, wherein the zeolite is located on a membrane as a solid covered membrane, and wherein the basic solution contacts the zeolite by flowing the basic solution through the solid covered membrane.

17. The method of claim 16, wherein the zeolite comprises bulk with a Si/Al>10.

18. The method of claim 17, wherein the zeolite comprises bulk with a Si/Al>20.

19. The method of claim 16, wherein the zeolite comprises a framework topology of AEL, AFI, CHA, DON, EMT, CFI, CLO, TON, FER, ERI, MEL, MTW, MWW, HEU, EUO, RHO, LTL, LTA or MAZ.

20. The method of claim 16, wherein the zeolite comprises a framework topology of MOR, MFI, BEA or FAU.

21. The method of claim 16, wherein the zeolite comprises a framework topology of FAU.

22. The method of claim 16, wherein the basic solution comprises an inorganic base.

23. The method of claim 22, wherein the inorganic base is selected from the group consisting of NH4OH, NaOH, KOH and LiOH

24. The method of claim 16, wherein the basic solution comprises an organic base or an organic supplement.

25. The method of claim 24, wherein the organic bases or the organic supplement is selected from the group consisting of: TPAOH, TPACl, TPABr, DEA, DPA, TBAOH and TEAOH.

26. The method of claim 16, wherein the contacting the zeolite with the basic solution occurs at a temperature between 40 and 70° C.

27. The method of claim 16, wherein the basic solution has a pH of at least 10 to at most 14.

28. The method of claim 16, wherein the ratio of the zeolite expressed in grams to the basic solution expressed in litres is between 1 g L-1 and 100 g L-1.

29. The method of claim 16, wherein the amount of base as part of the basic solution as it flows through the solid covered membrane is at most 3.0 mmol base per gram of zeolite per minute.

30. The method of claim 16, wherein the zeolite comprises a framework topology of FAU, wherein the ratio of the zeolite expressed in grams to the basic solution expressed in litres is between 1-100 g L-1, and wherein the amount of base as part of the basic solution as it flows through the solid covered membrane is at most 3.0 mmol base per gram of zeolite per minute.

31. The method of claim 30, wherein the basic solution comprises DEA.
